(19) United States
(12) Patent Application Publication
(10) Pub. No.: US 2007/0109606 A1
(43) Pub. Date: May 17, 2007

(54) Method of correcting ejection pattern data, apparatus for correcting ejection pattern data, liquid droplet ejection apparatus, method of manufacturing electro-optic device, electro-optic device, and electronic device

(75) Inventor: Nobuaki Nagae, Chino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/591,205

(22) Filed: Nov. 1, 2006

(30) Foreign Application Priority Data
Nov. 16, 2005 (JP) 2005-332180

(51) Int. Cl. H04N 1/409

(52) U.S. Cl. 358/3.26; 358/1.8

(57) ABSTRACT

In drawing processing, a function liquid droplet ejection head is moved relative to a workpiece to selectively eject function liquid droplets from a plurality of nozzles of the function liquid droplet ejection head according to ejection pattern data. Calculation is made of an amount given to each of a plurality of imaginary divided portions obtained by partitioning in matrix a drawing region on the workpiece. Matrix data representing in multi-valued gradation the amount of function liquid given to the plurality of imaginary divided portions is generated. N-valued matrix data is generated by converting the matrix data into n-valued data (n≧2). The ejection pattern data is corrected to decrease and/or increase the amount of function liquid given to the imaginary divided portions.

The entire disclosure of Japanese Patent Application No. 2005-332180, filed Nov. 16, 2005, is expressly incorporated by reference herein.

### BACKGROUND

1. Technical Field

The present invention relates to a method of correcting ejection pattern data in which ejection pattern data is corrected for performing drawing (or imaging) processing on a workpiece to selectively eject function liquid droplets from a plurality of nozzles of a function liquid droplet ejection head represented by an ink jet head. It also relates to an ejection pattern data correction apparatus, a liquid droplet ejection apparatus, a method of manufacturing an electro-optic device, an electro-optic device, and an electronic device.

2. Related Art

Conventionally, there is known a liquid droplet ejection apparatus for performing drawing processing in which an ink (a function liquid) is ejected from an ink ejection nozzle (nozzle) of an ink jet head (a function liquid droplet ejection head) toward a color filter (a workpiece) having arrayed therein plural rows of colored portions, the ejection being made based on ejection pattern data. Since the amount of ink to be ejected (ink ejection amount) is not uniform among the plurality of the ink ejection nozzles, the following correction is considered. Namely, in order to unify the ink ejection amount among the plural rows of colored portions, the color density is detected at each row of the colored portions. Based on the color density, the density of the ink to be ejected toward each row of the colored portions is corrected. JP-A-10-315510 is an example of related art.

In this kind of method of correcting the ejection pattern data, however, the ink ejection density among the plural rows of the colored portions is different from one another. Therefore, even if the ink ejection amount is unified among the plural rows of the colored portions, such unifying will be a positive cause for unevenness in drawing (or non-uniform drawing). In other words, the colored portions having different ink ejection density from one another will be arrayed in a row. As a result, when the color filter is viewed as a whole, the colored portions of that particular row will be recognized as an uneven row of the colored portion.

### SUMMARY

It is an advantage of the invention to provide a method of correcting ejection pattern data in which ejection pattern data can be corrected in such a manner that the viewer hardly realizes (notice) the drawing unevenness of a workpiece as a whole, as well as an apparatus for correcting ejection pattern data, a liquid droplet ejection apparatus, a method of manufacturing an electro-optic device, an electro-optic device, and an electronic device.

According to one aspect of the invention, there is provided a method of correcting ejection pattern data to eliminate drawing unevenness in drawing processing in which a function liquid droplet ejection head is moved relative to a workpiece to selectively eject function liquid droplets from a plurality of nozzles of the function liquid droplet ejection head according to ejection pattern data. The method comprises the steps of: calculating an amount of function liquid given in the drawing processing to each of a plurality of imaginary divided portions obtained by partitioning into matrix a drawing region on the workpiece; generating matrix data which represents in multi-valued gradation an amount of function liquid given to the plurality of imaginary divided portions; processing gradation by converting the matrix data into n-valued data to thereby generate n-valued matrix data, where n is an integer equal to or larger than 2; and correcting ejection pattern data so as to perform at least one of decreasing and increasing the amount of function liquid given to the imaginary divided portions. The amount is decreased where each of the n-valued data of the n-valued matrix data represents the side of “large,” and the amount is increased where each of the n-valued data of the n-valued matrix data represents the side of “small,” respectively, in the amount of function liquid given to the imaginary divided portions.

According to another aspect of the invention, there is provided an apparatus for correcting ejection pattern data to eliminate drawing unevenness in drawing processing in which a function liquid droplet ejection head is moved relative to a workpiece to selectively eject function liquid droplets from a plurality of nozzles of the function liquid droplet ejection head according to ejection pattern data. The apparatus comprises: a storing device for storing the ejection pattern data; a calculating device for calculating an amount of function liquid given in the drawing processing to each of a plurality of imaginary divided portions obtained by partitioning in matrix a drawing region on the workpiece; a data generating device for generating matrix data which represents in multi-valued gradation an amount of function liquid given to the plurality of imaginary divided portions; a gradation processing device to convert the matrix data into n-valued data to thereby generate n-valued matrix data, where n is an integer equal to or larger than 2; and a data correction device for correcting the ejection pattern data so as to perform at least one of decreasing and increasing the amount of function liquid given to the imaginary divided portions. The amount is decreased where each of the n-valued data of the n-valued matrix data represents the side of “large,” and the amount is increased where each of the n-valued data of the n-valued matrix data represents the side of “small,” respectively, in the amount of function liquid given to the imaginary divided portions.

According to these configurations, conversion into n-valued data is made of the matrix data based on the amount of function liquid given (or added) to each of the imaginary divided portions. As a result, the corrected ejection pattern data will adequately increase and/or decrease the amount of giving the function liquid to each of the imaginary divided portions. For example, suppose that matrix data is prepared by representing the amount of giving the function liquid in 10 stages from “0”, (function liquid giving amount: large) to “9” (function liquid giving amount: small) and that binarizing processing (i.e., conversion into 2-valued data) is performed. Then, in a region in which the function liquid giving amount is large, the 2-valued (binary) data in the imaginary divided portions partly becomes “0.” The amount of giving the function liquid for such imaginary divided portions is thereby decreased. The amount of giving the function liquid is thus decreased over the entire region in which the amount of giving the function liquid is large. The unevenness in drawing is eliminated, in this manner, in the workpiece as a whole. As a result, it is possible to correct the ejection pattern in such a manner that the viewer hardly realizes the unevenness in the workpiece as a whole.

In the above example, although a description was made about the binarizing processing, it is not necessary to limit the gradation processing to binarizing. Further, it is preferable that the number of gradation of the n-valued matrix data be set based on the adjustable number of the function liquid ejection amount per one shot. For example, in case the amount of function liquid ejection per one shot can be classed into large, medium, and small in shooting, the function liquid ejection amount may be 3-valued or further, by giving the case of no ejection, 4-valued.

It is preferable that, at the step of processing gradation, the n-valued matrix data be generated by conversion into n-valued data using one of a threshold value method, a systematic dither method, and an error diffusion (dispersion) method.

According to this configuration, it is possible to adequately carry out the conversion of the matrix data into n-valued data by means of a general and easy data processing. The error diffusion method is more preferable since, according to it, the more the region becomes rough, the more the apparent gradation can be improved. Unevenness in image can be made to be less recognizable.

It is preferable that the method further comprise the step of measuring, prior to the step of calculating an amount of function liquid, an ejection amount of the function liquid per unit shot to be ejected from a nozzle group made up of one or more of the nozzles corresponding to the imaginary divided portions. At the step of calculating an amount of function liquid, the function liquid giving amount is calculated based on a result of measuring the function liquid ejection amount and the ejection pattern data.

According to this configuration, the function liquid ejection amount can be measured by causing the function liquid to be ejected for inspection purpose out of the function liquid ejection head. As a result, the matrix data can be generated without performing drawing processing. Therefore, the drawing processing can be adequately performed from the first round of the workpiece.

It is preferable that the amount of function liquid ejection be measured by measuring the weight of the function liquid droplet, measuring the flight speed of the function liquid droplet, measuring the size of the function liquid droplet in flight, measuring the diameter of the function liquid droplet that has reached the target, and the like.

It is preferable that the method further comprise the step of measuring, prior to the step of calculating an amount of function liquid, an optical density, at each of the imaginary divided portions, of the film forming part formed on the workpiece by the function liquid in the drawing processing. At the calculating step, the function liquid giving amount is calculated based on a result of measuring the optical density.

According to this configuration, the amount of giving the function liquid is calculated based on the result of measuring the optical density of the film forming part formed on the workpiece. Therefore, the matrix data can be adequately generated based on the actual drawing result.

The optical density of the film forming part shall preferably be measured by means of transmittance measurement, absorbance measurement, reflectance measurement, and the like.

It is preferable that the method further comprise the step of measuring, prior to the step of calculating an amount of function liquid, a film thickness, at each of the imaginary divided portions, of the film forming part formed on the workpiece by the function liquid in the drawing processing. At the step of calculating an amount of function liquid, the function liquid giving amount is calculated based on a result of measuring the film thickness.

According to this configuration, the amount of giving the function liquid is calculated based on the result of measurement of the film thickness at the film forming part formed on the workpiece. Therefore, the matrix data can be adequately generated based on the result of actual drawing.

As the measurement of the film thickness at the film forming part, an optical interference method, a stylus method, and the like may be used.

It is preferable that the step of correcting data correct the ejection pattern data by at least one of increasing and decreasing the number of shots from each of the nozzles and the quantity of the function liquid ejection amount per one shot so as to increase or decrease the function liquid giving amount.

According to this configuration, by a simple control in which the number of shots from each of the nozzles is increased or decreased or in which the amount of function liquid ejection per one shot is increased or decreased, the amount of function liquid given to each of the imaginary divided portions can be increased or decreased.

It is preferable that the liquid droplet ejection apparatus comprise: a liquid droplet ejection head; a moving device for moving the function liquid droplet ejection head relative to a workpiece; and a head control device for controlling each of the nozzles of the function liquid droplet ejection head based on the ejection pattern data as corrected by the above-described method of correcting ejection pattern data.

According to this configuration, the drawing processing is performed by the corrected ejection pattern data in such a manner that the viewer hardly realizes the unevenness in drawing over the entire workpiece.

A method of manufacturing an electro-optic device comprises forming on a workpiece a film forming part by a function liquid droplet by using the above-described liquid droplet ejection apparatus.

An electro-optic device comprises a film forming part formed on the workpiece by the function liquid by using the above-described liquid droplet ejection apparatus.

According to these configurations, there is used the liquid droplet ejection apparatus which can perform drawing processing in which the viewer can hardly realize the unevenness in the workpiece as a whole. It is therefore possible to manufacture a high-quality electro-optic device. As the electro-optic device (flat panel display: FPD), there can be listed a color filter, a liquid crystal display device, an organic EL device, a PDP device, an electron emission device, and the like. The electron emission device is a concept which includes the so-called field emission display (FED) device, and a surface-conduction electron-emitter display (SED) device. Further, as the electro-optic device, there is considered a device which includes the one for forming a metallic wiring, for forming a lens, for forming a resist, for forming an optical dispersion body, and the like.

An electronic device according to the invention has mounted thereon the electro-optic device manufactured by the above-described method of manufacturing an electro-optic device, or the above-described electro-optic device.

As the electronic device, there can be listed a mobile telephone having mounted thereon a so-called flat panel display, a personal computer, and various kinds of electric appliances.

### BRIEF DESCRIPTION OF THE DRAWINGS

The invention will be described with reference to the accompanying drawings, wherein like numbers reference like elements.

FIG. 1 is a schematic plan view of a liquid droplet ejection apparatus according to one embodiment of the invention.

FIG. 2 is an external perspective view of a function liquid droplet ejection head mounted on the liquid droplet ejection apparatus.

FIG. 3 is a block diagram showing a control system of the liquid droplet ejection apparatus.

FIG. 4 is a flow chart showing the correction processing of ejection pattern correction data.

FIG. 5 is a schematic diagram showing a result of drawing by ejection pattern data before correction.

FIG. 6 is a diagram showing an example of multi-valued matrix data.

FIG. 7 is a diagram showing an example of 2-valued matrix data.

FIG. 8 is a schematic diagram showing the result of drawing by ejection pattern data after correction.

FIG. 9 is a flow chart showing the steps of manufacturing a color filter.

FIGS. 10A to 10E are schematic sectional views of the color filter as shown in the order of manufacturing steps.

FIG. 11 is a sectional view of an important portion showing a general arrangement of a liquid crystal device using the color filter to which the invention is applied.

FIG. 12 is a sectional view of an important portion showing a general arrangement of a liquid crystal device of a second example using the color filter to which this invention is applied.

FIG. 13 is a sectional view of an important portion showing a general arrangement of a liquid crystal device of a third example using the color filter to which this invention is applied.

FIG. 14 is a sectional view of an important portion of the display device which is an organic EL device.

FIG. 15 is a flow chart showing the steps of manufacturing the display device which is an organic EL device.

FIG. 16 is a process drawing showing the formation of an inorganic-matter bank layer.

FIG. 17 is a process drawing showing the formation of an organic-matter bank layer.

FIG. 18 is a process drawing showing the steps of manufacturing a hole injection/transport layer.

FIG. 19 is a process drawing showing the state in which the hole injection/transport layer has been formed.

FIG. 20 is a process drawing showing the steps of manufacturing the blue light emitting layer.

FIG. 21 is a process drawing showing the state in which the blue light emitting layer has been formed.

FIG. 22 is a process drawing showing the state in which the light emitting layer of each color has been formed.

FIG. 23 is a process drawing showing the steps of manufacturing the cathode electrode.

FIG. 24 is an exploded perspective view showing an important portion of the display device which is a plasma display device (PDP device).

FIG. 25 is a sectional view of an important portion of the display device which is an electron emission device (FED device).

FIGS. 26A and 26B are, respectively, a plan view around the electron emission device of the display device and a plan view showing the method of manufacturing the same.

### DESCRIPTION OF EXEMPLARY EMBODIMENTS

With reference to the accompanying drawings, a description will now be made about an embodiment of a liquid droplet ejection apparatus which performs drawing processing (or imaging or painting processing) based on ejection pattern data as corrected by an ejection pattern data correction method according to the invention. The liquid droplet ejection apparatus is built-in in a manufacturing line of a flat panel display, and forms light-emitting elements, and the like, which serve as a color filter for a liquid crystal display device and a light-emitting element for an organic EL device by a printing technology-(ink jet method) using a liquid droplet ejection head which serves as an ink jet head.

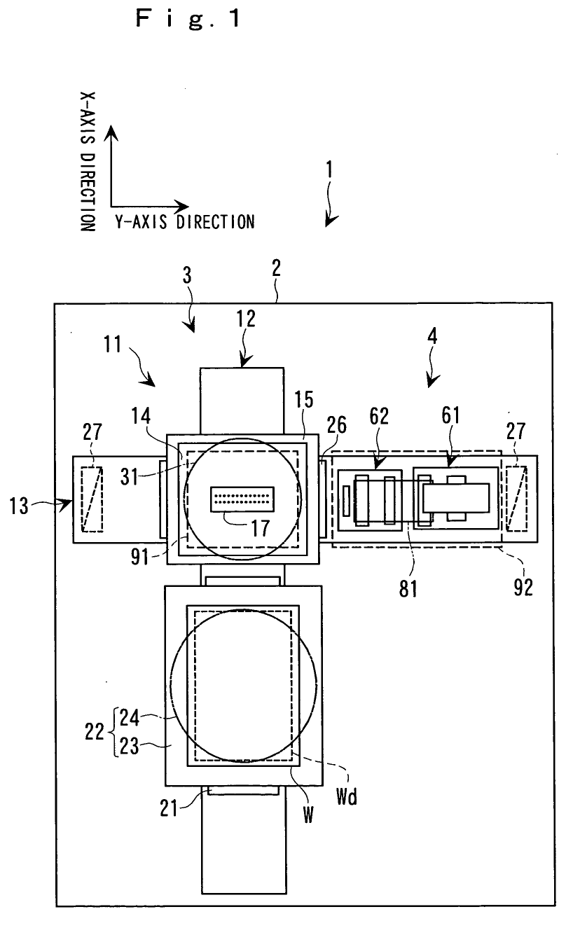

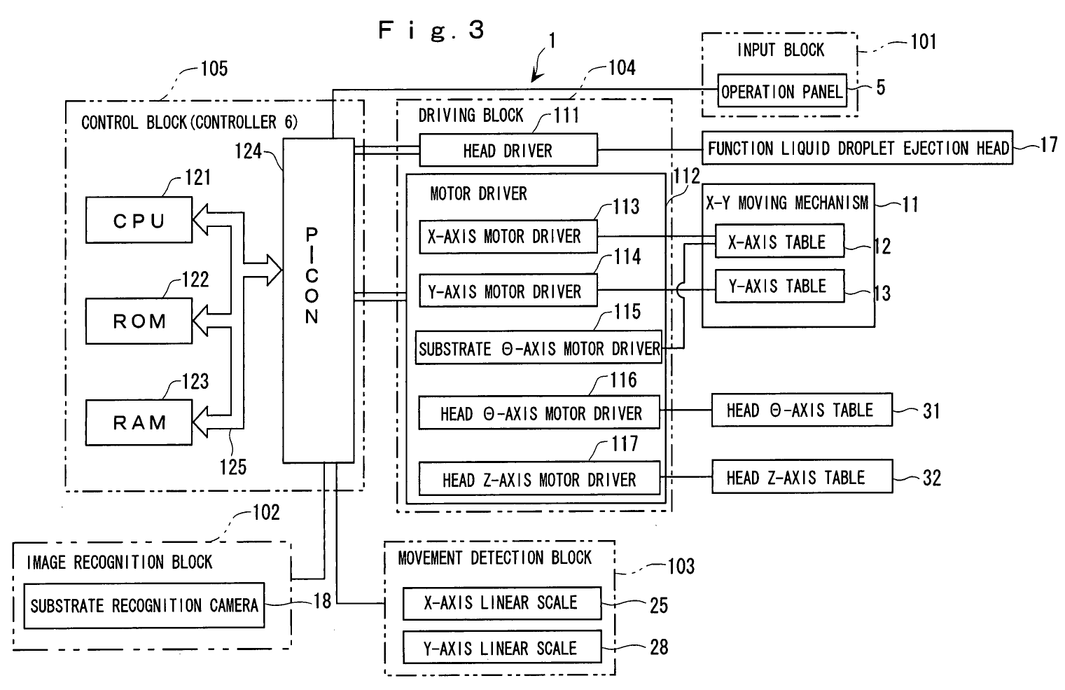

As shown in FIG. 1, the liquid droplet ejection apparatus 1 is made up of: an apparatus base 2; a drawing apparatus (imaging or painting apparatus) 3 having mounted thereon a function liquid droplet ejection head 17; and a maintenance apparatus 4 which is disposed on the apparatus 2 next to the drawing apparatus 3. In this configuration, maintenance processing (maintaining and recovering the function of the function liquid ejection head 17) is performed by the maintenance apparatus 4 and the drawing operation to eject the function liquid on a substrate W is performed by the drawing apparatus 3. The liquid droplet ejection apparatus 1 is further provided with: an operation panel 5 for inputting various data; a control block (controller 6, see FIG. 3) for performing overall control of various constituting members; and the like.

The drawing apparatus 3 is made up of: an X-Y moving mechanism 11 having an X-axis table 12 and a Y-axis table 13 which crosses the X-axis table 12 at right angles; a carriage 14 which is movably attached to the Y-axis table 13; and a head unit 15 which is vertically provided on the carriage 14. The head unit 15 has mounted thereon the function liquid droplet ejection head 17. The substrate W, on the other hand, is mounted on the X-axis table 12 in a state of being aligned by means of a pair of substrate recognition cameras 18 (see FIG. 3) which face an end portion of the X-axis table 12. Although a single piece of function liquid droplet ejection head 17 is mounted in this embodiment, the number thereof may be arbitrarily determined.

The X-axis table 12 is directly supported on the apparatus base 2 and is made up of: a motor-driven X-axis slider 21 which constitutes a driving system in the X-axis direction; a setting table 22 which has a suction table 23, substrate θ-axis table 24, and the like, and is movably mounted on the X-axis slider 21; and an X-axis linear scale 25 (see FIG. 3) which detects the momentary moving position of the setting table 22.

The Y-axis table 13 is supported by left and right supporting columns 27 which are vertically disposed on the apparatus base 2, and is elongated so as to bridge over the X-axis table 12 and the maintenance apparatus 4. The Y-axis table 13 is made up of: a motor-driven Y-axis slider 26 which has movably mounted thereon the carriage 14 so as to constitute a driving system in the Y-axis direction; and a Y-axis linear scale 28 (see FIG. 3) which detects the momentary moving position of the carriage 14.

The Y-axis table 13 is arranged to adequately move the head unit 15 mounted thereon between a drawing area 91 which is positioned right above the X-axis table 12 and a maintenance area 92 which is positioned right above the maintenance apparatus 4. In other words, the Y-axis table 13 operates to face the head unit 15 in the drawing area 91 when drawing operation is made on the substrate W introduced on the X-axis table 12, and operates to face the head unit 15 in the maintenance area 92 when maintenance processing is performed on the function liquid droplet ejection head 17.

The carriage 14 is made up of: a head θ-axis table 31 which causes the vertically disposed head unit 15 to rotate in normal and opposite directions of rotation (θ-rotation) by a very minute amount in a horizontal plane; and a head Z-axis table 32 (see FIG. 3) which causes the head unit 15 to move by a very minute amount in a Z-axis direction (vertical direction, i.e., a direction perpendicular to the drawing sheet of FIG. 1 as viewed by the viewer).

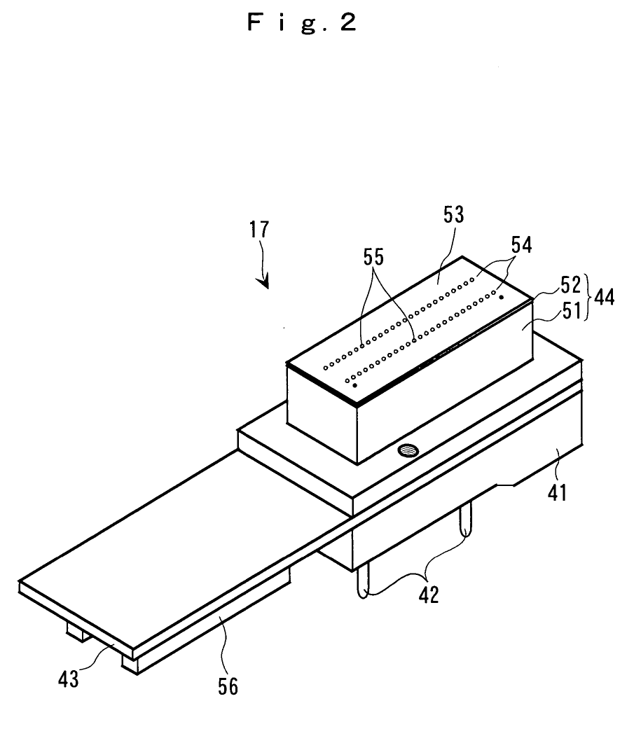

As shown in FIG. 2, the function liquid droplet ejection head 17 is to eject the function liquid with an ink jet method, and is made up of: a function liquid introducing part 41 having a dual-type connection needle 42; a dual-type head substrate 43 which is connected to the side of the function liquid introducing part 41; and a head main body 44 which is connected to the lower side (upper side in FIG. 2) of the function liquid introducing part 41 and has formed therein an in-head flow passage which is filled with the function liquid. The dual-type connection needles 42 are connected to a function liquid bag (not shown) through a liquid supply tube, thereby supplying the in-head flow passage of the function liquid ejection head 17 with the function liquid.

The head main body 44 is made up of: a pump part 51 which is constituted by a piezoelectric element, and the like; and a nozzle plate 52 which has a nozzle surface 53 having formed therein two rows of nozzle arrays 54 in parallel with each other.

Each of the nozzle arrays 54 is constituted by disposing a plurality of (e.g., 180) nozzles 55 at even intervals (e.g., 140 μm). Both the nozzle arrays 54 are disposed from each other by half a pitch (70 μm) in a direction in which the nozzles are arrayed. In other words, the nozzle pitch of the two nozzle arrays 54 is 70 μm.

The dual-type head substrate 43 is provided with a dual-type connector 56, each connector 56 being connected by means of a flexible flat cable to a head driver 111 (see FIG. 3) which is described hereinafter. A driving wave form is applied to each pump part 51 from the controller 6 through the head driver 111, whereby the function liquid is ejected from each nozzle 55.

The amount of ejection of the function liquid from each nozzle 55 can be adjusted to, e.g., three stages of large, medium and small by controlling the applied voltage value of the driving wave form. It is to be noted that the amount of ejection of the function liquid from each nozzle 55 is not uniform but varies or fluctuates from nozzle to nozzle even if the driving wave form of the same voltage value is applied, this fluctuation being caused by the construction of the in-head flow passage, and the like.

The maintenance apparatus 4 has in the maintenance area 92: a suction unit 61; and a wiping unit 62 which lies next to the suction unit 61 on the side of the drawing area 91 in the Y-axis direction. The suction unit 61 performs suction processing in which the function liquid is sucked from the nozzles 55 of the function liquid droplet ejection head 17. The wiping unit 62 performs wiping processing in which a nozzle surface 53 of the function liquid droplet ejection head 17 is wiped off with a wiping sheet 81.

With reference to FIG. 3, a description will now be made about the control system of the entire liquid droplet ejection apparatus 1. The control system of the liquid droplet ejection apparatus 1 is basically made up of: an input block 101 which has an operation panel 5; an image recognition block 102 which has the substrate recognition cameras 18 and image-wise recognizes the substrate W; a movement detection block 103 which has the X-axis linear scale 25 and the Y-axis linear scale 28 and detects the momentary positions of the setting table 22 and the carriage 14; a driving block 104 which has various drivers to drive the function liquid droplet ejection head 17, the X-Y moving mechanism 11, and the like; and a control block 105 (controller 6) which performs an overall control over the liquid droplet ejection apparatus 1 inclusive of the above blocks.

The driving block 104 is made up of: a head driver 111 which controls the driving of ejection of the function liquid droplet ejection head 17; and a motor driver 112 which controls the driving of each of the motors of the X-Y moving mechanism 11. The head driver 111 generates and applies the predetermined driving wave form according to the instructions of the control block 105 (details will be described hereinafter) to thereby control the driving for ejection of the function liquid droplet ejection head 17. The motor driver 112 has an X-axis motor driver 113, a Y-axis motor driver 114, a substrate θ-axis motor driver 115, a head θ-axis motor driver 116, and a head Z-axis motor driver 117. These drivers control the driving of each of the driving motors for the X-axis table 12, the Y-axis table 13, the substrate θ-axis table 24, the head θ-axis table 31, and the head Z-axis table 32 according to the instructions of the control block 105.

The control block 105 has a CPU 121, a ROM 122, a RAM 123, and a P-CON 124. They are connected to one another through a bus 125. The ROM 122 has a control program region which stores therein a control program to be processed in the CPU 121, and the like, and a control data region which stores therein control data for performing drawing processing and image recognition.

The RAM 123 has, aside from various register groups, a drawing data region which stores therein ejection pattern data for drawing processing, an image data region which temporarily stores therein image data, and a correction data region which stores therein correction data for correcting the position of the substrate W and the carriage 14, and the like, and is used as various working regions for control processing.

The P-CON 124 has built therein a logic circuit which supplements the function of the CPU 121 and also handles the interface signals with the peripheral circuits. Therefore, the P-CON 124 captures image data and various commands from the input block 101 as they are or with due processing and, in cooperation with the CPU 121, outputs to the driving block 104 the data and control signals which are outputted from the CPU 121, and the like as they are or with due processing.

The CPU 121 inputs various detection signals, various commands, various data, and the like, through the P-CON 124 according to the control program in the ROM 122, processes various data inside the RAM 123, and then outputs the various control signals to the driving block 104, and the like, through the P-CON 124, thereby performing an overall control over the liquid droplet ejection apparatus 1.

For example, the control block 105 controls the driving of the function liquid droplet ejection head 17 based on the ejection pattern data so that the function liquid droplets can be selectively ejected from each of the nozzles 55. In other words, the ejection pattern data is sequentially retrieved to correspond to the position of the substrate W and the position of the head unit 15 as detected by the X-axis linear scale 25 and the Y-axis linear scale 28. The retrieved ejection pattern data is converted into a driving signal (driving wave form) for the function liquid droplet ejection head 17 and is thereafter transmitted to the function liquid droplet ejection head 17. Based on the driving signal, the pump part 51 of the function liquid droplet ejection head 17 is driven, whereby the function liquid droplets can be selectively ejected from each of the nozzles 55.

The liquid droplet ejection apparatus 1 thus configured performs maintenance work of the function liquid droplet ejection head 17 by the maintenance apparatus 4 as required and also performs drawing operation on the substrate W by means of the drawing apparatus 3. In other words, the drawing apparatus 3 moves, while undergoing the control by the controller 6, the substrate W forward in the X-axis direction and, in a manner synchronized therewith, drives the function liquid droplet ejection head 17 to thereby perform main scanning on the substrate W. Then, after performing sub-scanning of the head unit 15 in the Y-axis direction by means of the Y-axis table 13, the substrate W is moved back in the X-axis direction and, in a manner synchronized therewith, the function liquid droplet ejection head 17 is driven to perform main scanning once again. By repeating the main scanning accompanied by the forward moving of the substrate W and the sub-scanning by the head unit 15 plural times, the ejection (drawing) of the function liquid is performed from end to end of (the drawing region Wd of) the substrate W.

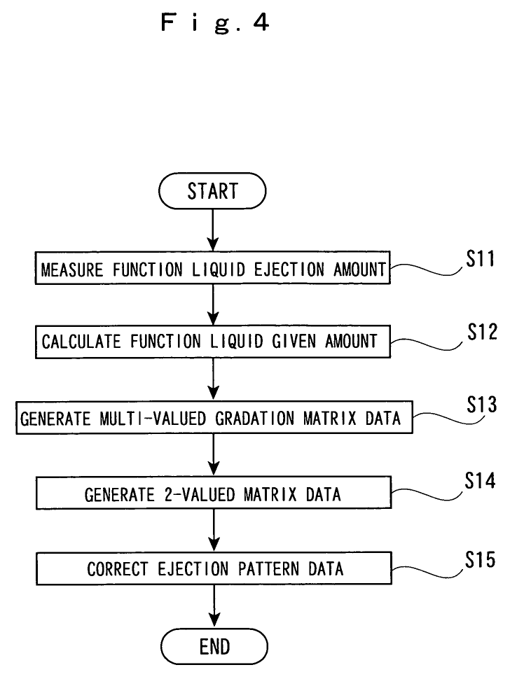

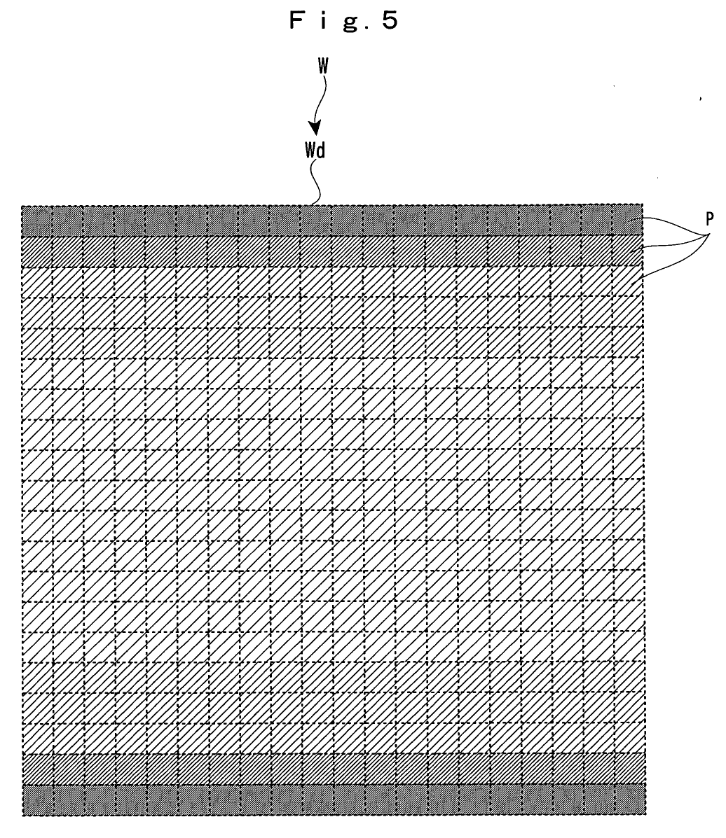

With reference to FIGS. 4 to 8, a description will now be made about the correction processing of the ejection pattern data, the processing being performed in the liquid droplet ejection apparatus 1. FIG. 5 is a schematic diagram showing the result of drawing (or imaging) by the ejection pattern data before correction. In this drawing operation, the regions on upper and lower end portions in the drawing region Wd of the substrate W are drawn (or pictured) thicker or darker. As described hereinabove, the amounts of ejecting the function liquid droplets from the plurality of nozzles 55 are not even or uniform. Therefore, even if the function liquid droplets are ejected from each of the nozzles 55 according to the ejection pattern data before correction, there will actually occur unevenness in drawing (also called drawing unevenness) as shown in the figure. Correction of the ejection pattern data is therefore performed.

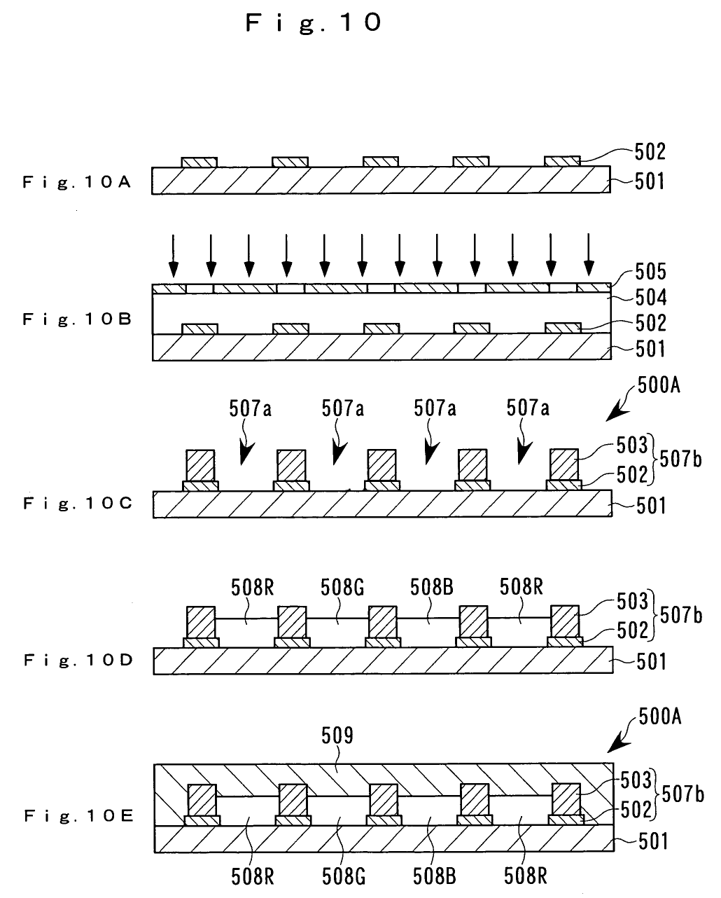

Reference alphabet P in the figure represents a plurality of imaginary divided portions to be obtained by partitioning or dividing into matrix the drawing region Wd on the substrate W. Each of the imaginary divided portions P is set to a size which substantially corresponds to the diameter of the shot function liquid droplet which hits (or reaches) the substrate W. However, the setting of the imaginary divided portion P is arbitrary. Each of the pixel regions 507a (see FIG. 10C, to be described in detail hereinafter) which are formed on the substrate W may alternatively be defined as the imaginary divided portion P.

Measurement is made of the amount of function liquid ejection per unit shot to be ejected from each of the nozzles 55 of the function liquid droplet ejection head 17 (S11 in FIG. 4) by means of an ejection amount measuring apparatus (not shown) which is provided apart from the liquid droplet ejection apparatus 1. The ejection amount measuring apparatus is made up of: an ejection apparatus which has mounted thereon the function liquid droplet ejection head 17 subjected to measurement and which controls the ejection driving of the function liquid droplet ejection head 17; a weight measuring device which measures the weight of the function liquid droplet ejected from the function liquid droplet ejection head 17 toward a receiving receptacle; and a computing apparatus which performs computing processing of the measuring result by the weight measuring device to thereby calculate the function liquid droplet ejection amount per unit shot to be ejected from each of the nozzles 55. The measuring result of the function liquid droplet ejection amount as obtained by this ejection amount measuring apparatus is inputted through the operation panel 5 of the liquid droplet ejection apparatus 1.

In case each of the pixel regions 507a is defined as each of the imaginary divided portions P, measurement is made, in the measurement of the function liquid droplet ejection amount, of the function liquid ejection amount per unit shot to be ejected out of the nozzle group which is made up of a plurality of nozzles 55 corresponding to each of the imaginary divided portions P (each of the pixel regions 507a). In other words, the weight of the function liquid ejection amount from each nozzle 55 may be measured to thereby calculate, based on the measuring result, the function liquid ejection amount of each nozzle group or, alternatively, the weight of the function liquid ejection amount from each nozzle group may be measured.

In this embodiment, an ejection amount measuring apparatus for measuring purpose is used aside from the liquid droplet ejection apparatus 1. It may alternatively be so arranged that the liquid droplet ejection apparatus 1 is provided with a weight measuring device. Further, aside from the weight measuring device for the function liquid droplet, it may be so arranged that the function liquid is pictured while in flight (from the time of ejecting out of the nozzle 55 to the time of hitting the workpiece) so as to measure the flight speed of, or the size of, the function liquid droplet. Or else, measurement may be made of the hitting diameter of the function liquid droplet that has hit the inspection workpiece whose surface has been subjected to surface treatment so as to have a given contact angle, to thereby measure the ejected amount of the function liquid.

Subsequently, based on the measuring result of the function liquid ejection, and on the ejection pattern data before correction (number of shots of the function liquid droplets relative to the imaginary divided portions P), calculation is made of the amount of the function liquid given (added or injected) to the plurality of imaginary divided portions P by the drawing processing based on the ejection pattern data before correction (S12). Here, the amount of giving the function liquid becomes relatively “large” in the regions on both upper and lower ends.

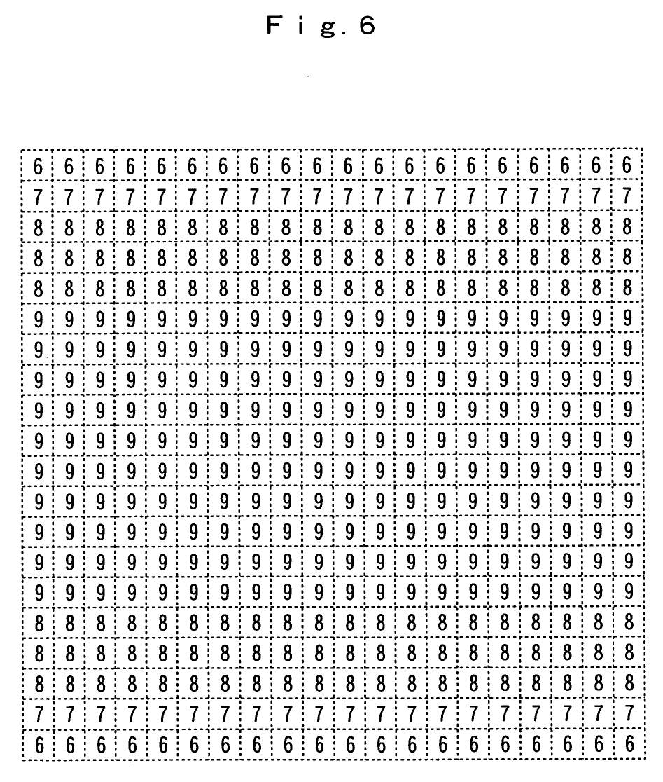

Subsequently, the control block 105 generates matrix data representing the amount of giving the function liquid to the plurality of imaginary divided portions P respectively in multi-valued gradation (S13, see FIG. 6). Here, the amount of giving the function liquid is represented in 10 grades from “0” (amount of giving function liquid: large) to “9” (amount of giving function liquid: small).

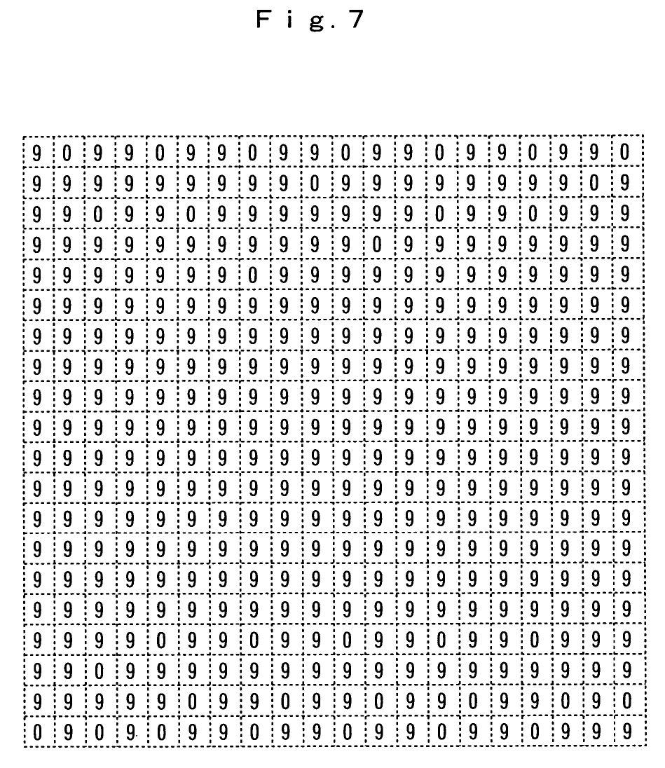

Then, the control block 105 generates 2-valued (binary) matrix data by converting the multi-valued gradation matrix data into 2-valued data (or binary value) (S14, see FIG. 7). Binarizing or conversion into 2-valued data (pseudo-gradation processing) is performed by an error diffusion method using, e.g., the Floyd-Steinberg dithering method as a delay and attenuation filter. As a result, the 2-valued data in the imaginary divided portions P partly becomes “0” in the regions on the side of both upper and lower ends, which are drawn thicker or darker, in the drawing regions W. As a general and easy data processing, there may be used a threshold method and a systematic dither method, aside from the error diffusion method. However, by using the error diffusion method, the rougher the region becomes, the more the apparent gradation can be improved. Therefore, it becomes possible for the viewer to hardly realize the drawing unevenness.

Finally, the control block 105 corrects the ejection pattern data stored in the RAM 123 such that each 2-valued data in the 2-valued matrix data becomes “0,” i.e., such that the amount of giving the function liquid to each of the imaginary divided portions P representing “large” of the function liquid giving amount decreases (S15). In other words, the ejection pattern data is corrected such that the function liquid droplet is not ejected from each nozzle 55 toward each of the imaginary divided portions P whose 2-valued data has become “0.” According to this processing, the amount of giving the function liquid is decreased toward the entire region in both upper and lower ends where the function liquid was given in a larger quantity. As a result, the drawing unevenness disappears in the substrate W (drawing region Wd) as a whole. In order to prevent the dots from failing to be ejected, correction may be made such that, instead of non-ejection, liquid droplets smaller in liquid amount than ordinary function liquid droplets are ejected. In other words, it may be so arranged that the driving signal smaller in an applied voltage value is generated.

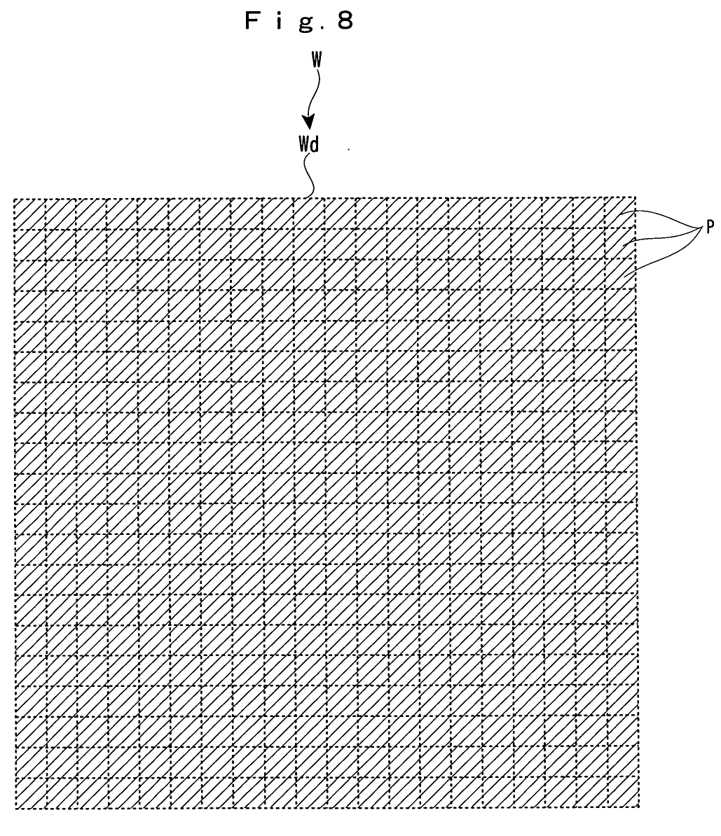

By performing drawing processing with the liquid droplet ejection apparatus 1 based on the ejection pattern data as corrected in the manner as described above, each of the imaginary divided portions P where the 2-valued data has become “0” is thinned out so that the function liquid droplets can be ejected to hit each of the remaining imaginary divided portions P. Therefore, it is possible to provide a substrate W in which the viewer can hardly realize the drawing unevenness as a whole (see FIG. 8).

In the above embodiment, a description is made about the 2-valued processing. However, the gradation need not be limited to the 2-valued processing. For example, take as an example of 4-valued processing (function liquid giving amount large: “0”—function liquid giving amount small: “3”). Data correction may be made such that the function liquid giving amount is gradually reduced to each of the imaginary divided portions P representing the “large” side in the function liquid giving amount. Namely, data correction is made such that smaller liquid droplets are ejected from each nozzle 55 to each of the imaginary divided portions P whose 4-valued data has become “1,” and that no function liquid is ejected from each nozzle 55 to each of the imaginary divided portions P whose 4-valued data has become “0.” Further, in case the amount of function liquid ejection can be classed into large, medium, and small per each shot in shooting, data correction is made such that the 4-valued data and the amount of function liquid ejection per each shot correspond to each other. In other words, data correction is made such that large liquid droplets are ejected in case 4-valued data is “3,” that medium liquid droplets are ejected in case 4-valued data is “2,” that small liquid droplets are ejected in case 4-valued data is “1,” and that no liquid droplets are ejected in case 4-valued data is “0.”

In case each of the pixel regions 507a is defined as each of the imaginary divided portions P as described above, the number of shots to each of the imaginary divided portions P whose 2-valued data has become “0” is arranged to be decreased. For example, suppose that the ejection pattern before correction is to eject 10 shots from respective five nozzles 55, i.e., a total of 50 shots. It may, then, be corrected to eject a total of 49 shots by having one nozzle 55 shoot 9 shots.

The ejection pattern data may alternatively be corrected so as to increase the amount of giving the function liquid to each of the imaginary divided portions P where each of the 2-valued data of the 2-valued matrix data represents the function liquid giving amount “small.” The ejection pattern data may also be corrected so that both increase and decrease in the amount of giving the function liquid can be performed.

In a manner opposite to the above example, the following method may also be employed. Namely, in case the amount of giving the function liquid to the regions on both sides of the upper and lower ends is relatively “small,” the amount of giving the function liquid is represented, in a manner opposite to the above example, to be “0” for the function liquid giving amount “small” and to be “9” for the function liquid giving amount “large.” The multi-valued gradation matrix data similar to the above example can thus be obtained. Binarization processing (conversion into 2-valued data) is similarly performed to correct the ejection pattern data such that an increase is made (by, e.g., ejecting liquid droplets which are larger in liquid amount than ordinary function liquid droplets) of the amount of giving the function liquid to each of the imaginary divided portions P where each of the 2-valued data in the 2-valued matrix data has become “0.” According to this configuration, the amount of giving the function liquid is increased in the region as a whole on both upper and lower ends where the amount of giving the function liquid was small, whereby the drawing unevenness in the substrate W as a whole can be eliminated.

In this embodiment, the amount of giving the function liquid is calculated based on the measuring result of the amount of function liquid ejection. Alternatively, the amount of function liquid ejection may be calculated based on the result of measuring an optical density or a film thickness at each of the imaginary divided portions P of the film forming part (e.g., color layers 508R, 508G, 508B to be described hereinafter, see FIGS. 10D and 10E).

In other words, drawing processing is performed in advance by the liquid droplet ejection apparatus 1 based on the ejection pattern data before correction, thereby forming a film-forming part on the substrate W. After the drawing processing, the substrate W is transported out of the liquid droplet ejection apparatus 1, and the optical density or the film thickness is measured by an optical density measuring apparatus or a film thickness measuring apparatus (both not shown). Based on the result of the measuring, the amount of giving the function liquid is calculated. Thereafter, in a manner similar to the above example, the ejection pattern data is corrected, and the subsequent drawing processing is performed.

In this manner, the multi-valued gradation matrix data can be adequately generated based on the result of the actual drawing. Alternatively, by measuring the amount of function liquid ejection as in this example, the multi-valued gradation matrix data can be generated without performing the drawing processing. It is thus possible to adequately perform the drawing processing from the first round of the workpiece W.

As the optical density measuring apparatus, there may be used one which is constituted by a transmittance measuring device, an absorbance measuring device, or a reflectance measuring device. Further, as the film-thickness measuring apparatus, an optical interference type or of a stylus type may be used. It is of course possible to provide the liquid droplet ejection apparatus 1 with an optical density measuring apparatus or a film thickness measuring apparatus.

As described hereinabove, according to the ejection pattern correction processing of this embodiment, the multi-valued gradation matrix data is processed by 2-valued conversion based on the amount of function liquid giving to each of the imaginary divided portions P. Therefore, the corrected ejection pattern can adequately perform the increase and/or decrease in the amount of giving the function liquid to each of the imaginary divided portions P. As a result, the ejection pattern can be corrected so that the viewer hardly realizes the drawing unevenness on the substrate W as a whole.

A description will now be made about a color filter, a liquid crystal display device, an organic electroluminescence (EL) device, a plasma display panel (PDP) device, an electron emission device (FED device, SED device) as an electro-optic device (flat panel display) to be manufactured by using the liquid droplet ejection apparatus 1 of this embodiment. A description will further be made about the construction and the method of manufacturing the same by taking, as an example, an active matrix substrate, and the like, which is formed into the above display device. The active matrix substrate means a substrate in which a thin film transistor, a source line and data line to be electrically connected to the thin film transistor are formed.

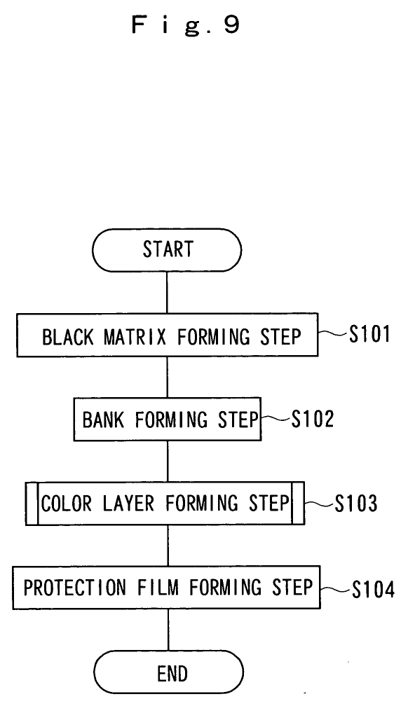

First, a description will be made about the method of manufacturing a color filter which is built or assembled in a liquid crystal display device, an organic EL device, and the like. FIG. 9 is a flow chart showing the manufacturing steps of the color filter, and FIGS. 10A to 10E are schematic cross-sectional views showing the color filter 500 (filter base member 500A) of this embodiment, as shown in the order of manufacturing steps.

First, at the black matrix forming step (S101), as shown in FIG. 10A, a black matrix 502 is formed on a substrate (W) 501. The black matrix 502 is formed of metallic chrome, a laminated member of metallic chrome and chrome oxide, or of resin black, and the like. In order to form the black matrix 502 made of a metallic thin film, sputtering method, vapor deposition method, and the like, may be used. In addition, in case the black matrix 502 made of a resin thin film is formed, gravure printing method, photo-resist method, thermal transfer method, and the like, may be used.

Then, at a bank forming step (S102), a bank 503 is formed in a state of being superimposed on the black matrix 502. In other words, as shown in FIG. 10B, there is formed a resist layer 504 which is made of a negative type of transparent photosensitive resin so as to cover the substrate 501 and the black matrix 502. Then, the upper surface thereof is subjected to exposure processing in a state of being coated with a mask film 505 which is formed in a shape of a matrix pattern.

As shown in FIG. 10C, the un-exposed portion of the resist layer 504 is subjected to etching processing to perform patterning of the resist layer 504, thereby forming a bank 503. In case the black matrix is formed by the resin black, it becomes possible to commonly use the black matrix and the bank.

The bank 503 and the black matrix 502 placed thereunder become a partition wall portion 507b which partitions each of pixel regions 507a, thereby defining a shooting or firing region by the function liquid droplets (i.e., a region in which the function liquid droplets hit the target) at the subsequent color layer forming step to form the color layers (film forming layers) 508R, 508G, 508B with the function liquid droplet ejection head 17.

By performing the above-described black matrix forming step and the bank forming step, the above-described filter base member 500A can be obtained.

As the material for the bank 503, there is used in this embodiment a resin material whose surface of coated film becomes liquid-repellent (water-repellent). Since the surface of the substrate (glass substrate) 501 is hydrophilic (water-receptive), a variation in shooting the liquid droplet into each of the pixel regions 507a enclosed by the bank 503 (partition wall portion 507b) is automatically improved in the below-described color layer forming step.

At the subsequent color layer forming step (S103), as shown in FIG. 10D, the function liquid droplet is ejected by the function liquid droplet ejection head 17 to thereby cause the liquid droplet to be shot or fired into each of the pixel regions 507a enclosed by the partition wall portion 507b. At this color layer forming step, the function liquid droplet ejection heads 17 is used to thereby eject three colors of red (R), green (G), and blue (B) function liquids (filter materials). As the arrangement pattern of three colors of R-G-B, there are stripe arrangement, mosaic arrangement, delta arrangement, and the like.

Thereafter, after drying processing (processing of heating, and the like), the function liquid is caused to be fixed to thereby form color layers 508R, 508G, 508B of three colors. Once the color layers 508R, 508G, 508B have been formed, the step transfers to a protection film forming step (S104). As shown in FIG. 10E, a protection film 509 is formed to cover the upper surface of the substrate 501, the partition wall portion 507b, and the color layers 508R, 508G, 508B.

In other words, after having ejected the protection film coating liquid over that entire surface of the substrate 501 on which the color layers 508R, 508B, 508G are formed, the protection film 509 is formed through the drying step.

After having formed the protection film 509, the color filter 500 transfers to the next step of forming a film such as ITO (Indium Tin Oxide) which forms a transparent electrode.

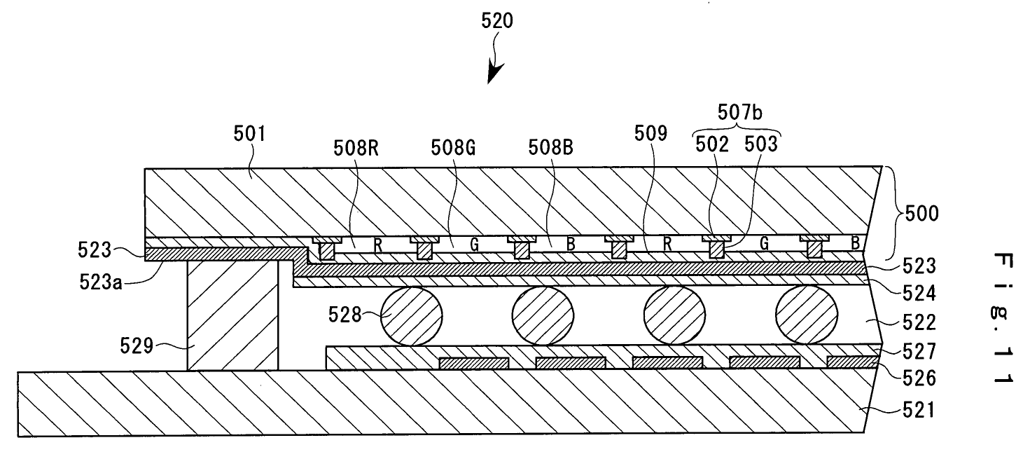

FIG. 11 is a sectional view of an important portion showing a general structure of a passive matrix type of liquid crystal device (liquid crystal device) as an example of a liquid crystal display device employing the above-described color filter 500. By mounting auxiliary elements such as a liquid crystal driving integrated circuit (IC), a backlight, a supporting member, and the like, on this liquid crystal device 520, there is obtained a transmission liquid crystal display device as a final product. The color filter 500 is the same as that shown in FIGS. 10A to 10E. Therefore, the same reference numerals are affixed to the corresponding parts/portions and the explanation thereabout is omitted.

This liquid crystal device 520 is made up substantially of: a color filter 500; an opposite substrate 521 made of a glass substrate, and the like; and a liquid crystal layer 522 which is made up of a super twisted nematic (STN) liquid crystal composition interposed therebetween. The color filter 500 is disposed on the upper side as seen in the figure (i.e., on the side from which the viewer looks at the color filter).

Although not shown, on an outside surface of the opposite substrate 521 and of the color filter 500 (i.e., the surface which is opposite to the liquid crystal layer 522), there is respectively disposed a polarizer. On an outside of the polarizer which is positioned on the side of the opposite electrode 521, there is disposed a backlight.

On the protection film 509 (on the side of the liquid crystal layer) of the color filter 500, there are disposed at predetermined intervals a plurality of rectangular first electrodes 523 which are elongated in the left and right direction as seen in FIG. 11. A first alignment film 524 is formed so as to cover that side of the first electrode 523 which is opposite to the color filter 500.

On that surface of the opposite substrate 521 which lies opposite to the color filter 500, a plurality of second electrodes 526 are formed at predetermined intervals to one another in a direction at right angles to the first electrode 523. A second alignment film 527 is formed so as to cover that surface of the second electrode 526 which is on the side of the liquid crystal layer 522. The first electrode 523 and the second electrode 526 are formed by a transparent conductive material such as indium tin oxide (ITO).

The spacer 528 which is provided inside the liquid crystal layer 522 is a material to keep the thickness of the liquid crystal layer 522 (cell gap) constant. The sealing material 529 is a material to prevent the liquid crystal composition inside the liquid crystal layer 522 from leaking outside. One end of the first electrode 523 is extended to the outside of the sealing material 529 as a running cable 523a.

The crossing portions between the first electrode 523 and the second electrode 526 are the pixels. It is thus so arranged that the color layers 508R, 508G, 508R of the color filter 500 are positioned in these portions which form the pixels.

At the ordinary manufacturing steps, the color filter 500 is coated with the patterning of the first electrode 523 and the first alignment film 524, to thereby form the portion on the side of the color filter 500. Aside from the above, the opposite substrate 521 is coated with the patterning of the second electrode 526 and the second alignment film 527, to thereby form the portion on the side of the opposite substrate 521. Thereafter, the spacer 528 and the sealing material 529 are formed into the portion on the side of the opposite substrate 521, and the portion on the side of the color filter 500 is adhered to the above-described portion in that state. Then, the liquid crystal which forms the liquid crystal layer 522 is filled from an inlet port of the sealing material 529, and the inlet port is closed thereafter. Thereafter, both the polarizers and the backlight are laminated.

In the liquid droplet ejection apparatus 1 of this embodiment, the spacer material (function liquid) which forms, e.g., the cell gap is coated. And, before the portion on the side of the color filter 500 is adhered to the portion on the side of the opposite substrate 521, the liquid crystal (function liquid) can be uniformly coated on the region enclosed by the sealing material 529. It is also possible to carry out the printing of the sealing material 529 with the function liquid droplet ejection head 17. Further, it is also possible to perform the coating of the first and second alignment films 524 and 527 by the function liquid droplet ejection head 17.

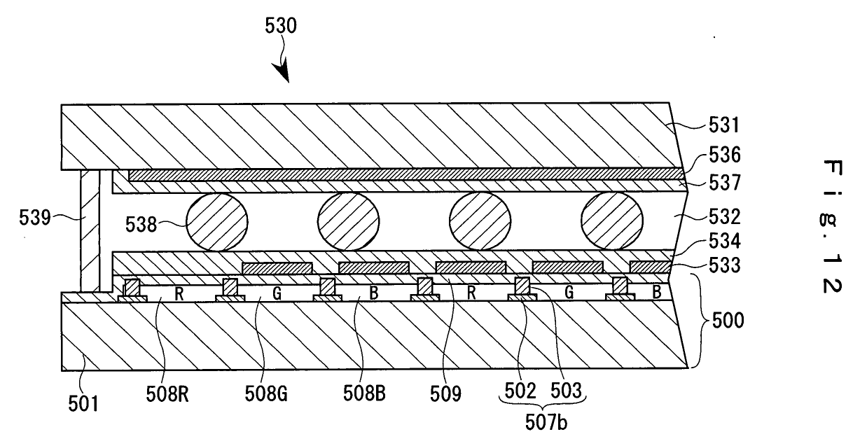

FIG. 12 is a sectional view of an important portion showing a general structure of a second example of the liquid crystal device using a color filter 500 manufactured in this embodiment.

What this liquid crystal device 530 is largely different from the above-described liquid crystal device 520 is that the color filter 500 is disposed on the lower side as seen in the figure (i.e., on the side opposite to the side from which the viewer looks at the device).

This liquid crystal device 530 is substantially constructed such that a liquid crystal layer 532 which is made of an STN liquid crystal is sandwiched between the color filter 500 and the opposite substrate 531 which is made by a glass substrate, and the like. Although not shown, a polarizer, and the like, are disposed on the outside surface of the opposite substrate 531 and the color filter 500, respectively.

On the protection film 509 (on the side of the liquid crystal layer 532) of the color filter 500, there are disposed at predetermined intervals a plurality of rectangular first electrodes 533 which are elongated in a direction at right angles to the surface of the drawing sheet. A first alignment film 534 is formed so as to cover that side of the first electrode 533 which is on the side of the liquid crystal layer 532.

On that surface of the opposite substrate 531 which lies opposite to the color filter 500, a plurality of second electrodes 536 are formed at predetermined intervals to one another in a direction at right angles to the first electrode 533. A second alignment film 537 is formed so as to cover that surface of the second electrode 536 which is on the side of the liquid crystal layer 532.

The liquid crystal layer 532 is provided with a spacer 538 to keep the thickness of the liquid crystal layer 532 constant and a sealing material 539 to prevent the liquid crystal composition inside the liquid crystal 532 layer from leaking outside.

In the same manner as in the above-described liquid crystal device 520, the crossing portions between the first electrode 533 and the second electrode 536 are the pixels. It is thus so arranged that the color layers 508R, 508G, 508B of the color filter 500 are positioned in these portions which form the pixels.

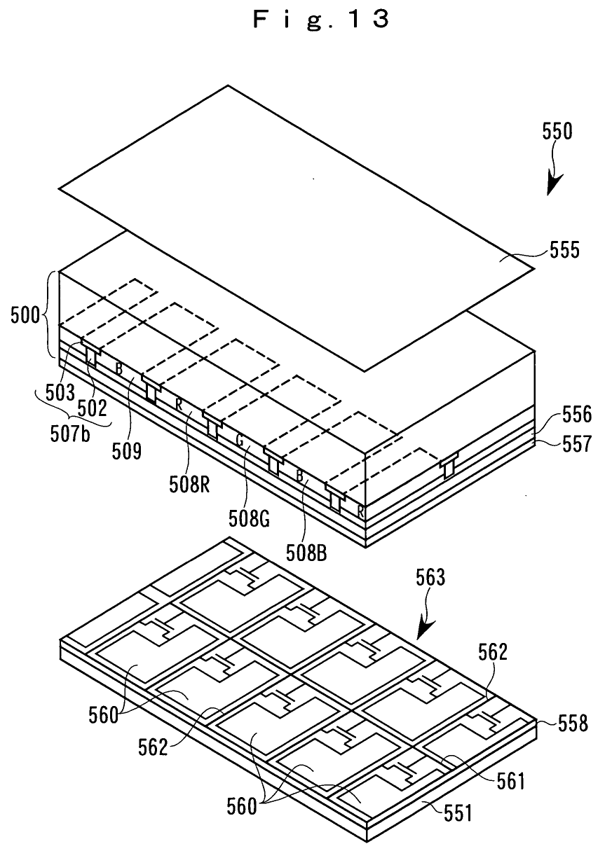

FIG. 13 is an exploded perspective view of an important portion showing a general structure of a third example of a transmission thin film transistor (TFT) liquid crystal device using a color filter 500 to which this invention is applied.

This liquid crystal device 550 has a construction in which the color filter 500 is disposed on the upper side as seen in the figure (i.e., on the side of the viewer).

This liquid crystal device 550 is made up of: the color filter 500; an opposite substrate 551 which is disposed to lie opposite to the color filter 500; a liquid crystal layer (not shown) which is sandwiched therebetween; a polarizer 555 which is disposed on the upper side (on the side of the viewer) of the color filter 500; and a polarizer (not shown) which is disposed on the lower side of the opposite electrode 551.

On the surface (i.e., the surface on the side of the opposite substrate 551) of a protection film 509 of the color filter 500, there is formed an electrode 556 for the liquid crystal driving. This electrode 556 is made of a transparent conductive material such as an ITO, and is formed into an entire-surface electrode which covers the entire region in which the pixel electrodes 560 (to be described later) are formed. An alignment film 557 is disposed in a state of covering the opposite surface of this pixel electrodes 560 of the electrode 556.

On that surface of the opposite substrate 551 which lies opposite to the color filter 500, there is formed an insulating layer 558. On this insulating layer 558, there are formed scanning lines 561 and signal lines 562 in a state of crossing each other at right angles. Pixel electrodes 560 are formed inside the regions enclosed by the scanning lines 561 and the signal lines 562. In the actual liquid crystal device, there will be disposed an alignment film (not shown) on the pixel electrode 560.

In the notched portion of the pixel electrode 560 and in the portion which is enclosed by the scanning line 561 and the signal line 562, there are built in or assembled a thin film transistor 563 which is provided with a source electrode, a drain electrode, a semiconductor, and a gate electrode. By applying signals to the scanning line 561 and the signal line 562, the thin film transistor 563 can be switched on and off so as to control the supply of electric current to the pixel electrode 560.

Although the above-described liquid crystal devices 520, 530, and 550 of each of the above examples is constituted into a transmission type, it may also be constituted into a reflective type of liquid crystal device or into a translucent reflective type of liquid crystal device by providing a reflective layer or a translucent reflective layer, respectively.

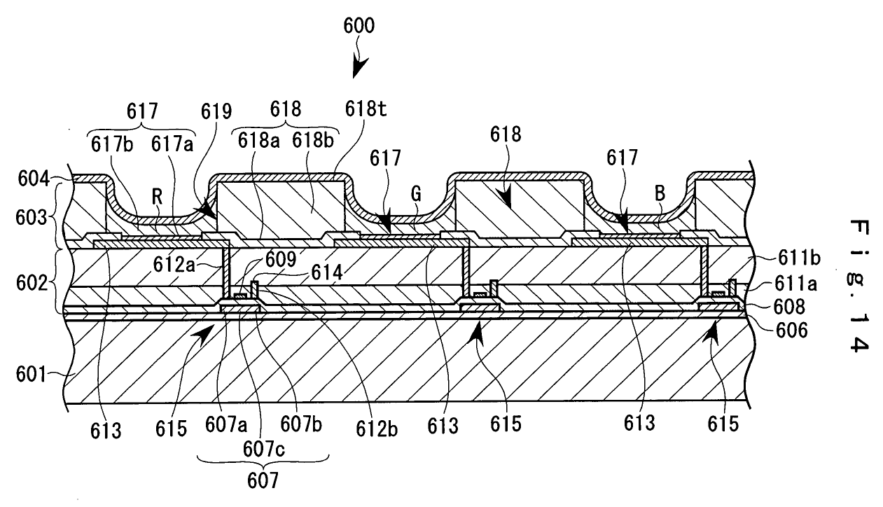

FIG. 14 is a sectional view of an important portion of an organic EL device (hereinafter simply referred to as a display device 600).

This display device 600 is substantially constituted by a substrate 601 (W), and on this substrate are laminated a circuit element part 602, light-emitting element part 603 and a cathode 604.

In this display device 600, the light emitted from the light-emitting element part 603 toward the substrate 601 passes through the circuit element part 602 and the substrate 601 for ejection toward the viewer, and the light emitted from the light-emitting element part 603 toward the side opposite to the substrate 601 is reflected by the cathode 604 and then passes through the circuit element part 602 and the substrate 601 for ejection toward the viewer.

Between the circuit element part 602 and the substrate 601, there is formed a base protection film 606 which is made of a silicon oxide film. On the top of this base protection film 606 (on the side of the light-emitting element 603), there is formed an island-shaped semiconductor film 607 which is made of polycrystalline silicon. In the left and right regions of this semiconductor film 607, there are respectively formed a source region 607a and a drain region 607b by high-concentration anion implantation. The central portion which is free from anion implantation becomes a channel region 607c.

In the circuit element part 602, there is formed a transparent gate insulation film 608 which covers the base protection film 606 and the semiconductor film 607. In that position on this gate insulation film 608 which corresponds to the channel region 607c of the semiconductor film 607, there is formed a gate electrode 609 which is made up of Al, Mo, Ta, Ti, W, and the like. On the top of this gate electrode 609 and the gate insulation film 608, there are formed a transparent first interlayer dielectric film 611a and a second interlayer dielectric film 611b. Through the first and the second interlayer dielectric films 611a and 611b, there are formed contact holes 612a and 612b which are in communication with the source region 607a and the drain region 607b, respectively, of the semiconductor film 607.

On the top of the second interlayer dielectric film 611b, there is formed, by patterning, a transparent pixel electrode 613 which is made of ITO, and the like. This pixel electrode 613 is connected to the source region 607a through the contact hole 612a.

On the top of the first interlayer dielectric film 611a, there is formed an electric source wiring 614, which is connected to the drain region 607b through the contact hole 612b.

As described hereinabove, the circuit element part 602 has formed therein a driving thin film transistor 615 which is connected to each of the pixel electrodes 613.

The above-described light-emitting element part 603 is substantially made up of: a function layer 617 which is laminated on each of the plurality of pixel electrodes 613; and a bank part 618 which is provided between each of the pixel electrodes 613 and the function layers 617 to thereby partition each of the function layers 617.

The light-emitting element is constituted by these pixel electrodes 613, the function layer 617, and the cathode 604 which is disposed on the function layer 617. The pixel electrode 613 is formed into a substantial rectangle as seen in plan view, and the bank part 618 is formed between each of the pixel electrodes 613.

The bank part 618 is made up of: an inorganic-matter bank layer 618a (first bank layer) which is formed by inorganic materials such as SiO, SiO₂, and TiO₂; and an organic-matter bank layer 618b (second bank layer) which is trapezoidal in cross section and which is formed by a resist superior in heat-resistance and solvent-resistance such as an acrylic resin, and a polyimide resin. Part of this bank part 618 is formed in a state of being overlapped with the peripheral portion of the pixel electrode 613.

Between each of the bank parts 618, there is formed an opening part 619 which is gradually enlarged in an upper direction relative to the pixel electrode 613.

The function layer 617 is made up of: a hole injection/transport layer 617a which is formed inside the opening part 619 in a state of being laminated on the pixel electrode 613; and a light-emitting layer 617b which is formed on this hole injection/transport layer 617a. It may be so arranged that other function layers having other functions are further formed adjacent to the light-emitting layer 617b. For example, an electron transport layer may be formed.

The hole injection/transport layer 617a has a function of transporting holes from the pixel electrode 613 side for injection into the light-emitting layer 617b. This hole injection/transport layer 617a is formed by ejecting the first composition of matter (function liquid) containing therein the hole injection/transport layer forming material. As the hole injection/transport layer forming material, there may be used a known material.

The light-emitting layer 617b emits light of red (R), green (G) or blue (B), and is formed by ejecting the second composition of matter (function liquid) containing the light-emitting layer forming material (light-emitting material). As the solvents for the second composition of matter (nonpolar solvent), it is preferable to use a known material which is insoluble to the hole injection/transport layer 120a. By using this kind of nonpolar solvent as the second composition of matter of the light-emitting layer 617b, the light-emitting layer 617b can be formed without dissolving the hole injection/transport layer 617a again.

The light-emitting layer 617b is so arranged that the holes injected from the hole injection/transport layer 617a and the electron injected from the cathode 604 get bonded again in the light-emitting layer to thereby emit light.

The cathode 604 is formed in a state to cover the entire surface of the light-emitting element part 603 and, in cooperation with the pixel electrode 613, functions to cause the electric current to flow to the function layer 617. A sealing member (not shown) is disposed on the top of this cathode 604.

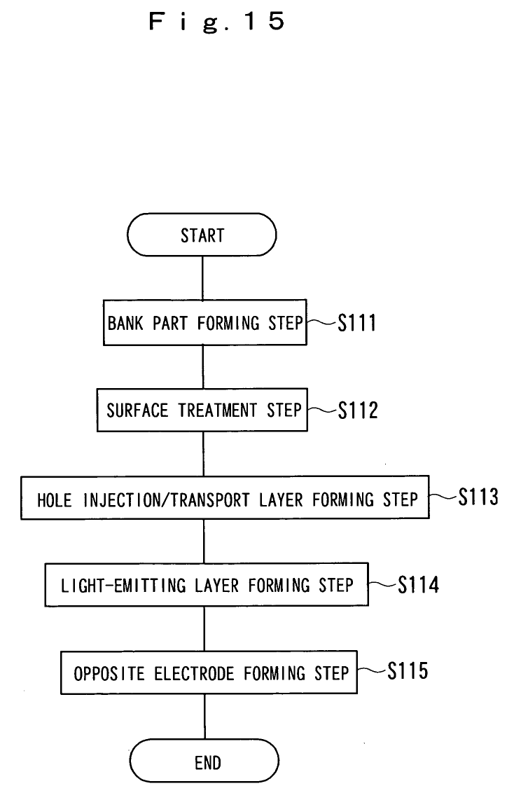

A description will now be made about the manufacturing steps of the above-described display device 600 with reference to FIGS. 15 to 23.

As shown in FIG. 15, this display device 106 is manufactured through the following steps, i.e., a bank part forming step (S111), a surface treatment step (S112), a hole injection/transport layer forming step (S113), a light-emitting layer forming step (S114), and an opposite electrode forming step (S115). The manufacturing steps need not be limited to the ones shown above; some steps may be omitted or others added if necessary.

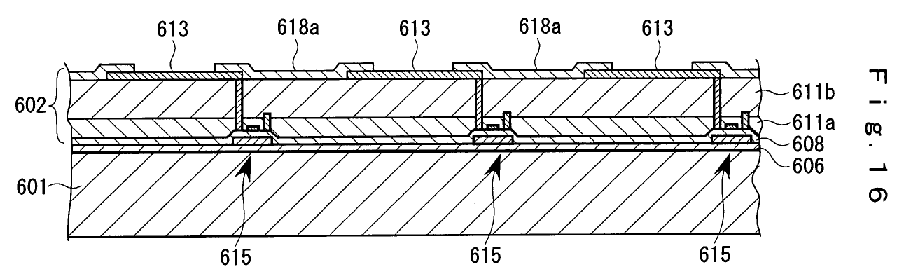

First, at the bank part forming step (S111), an inorganic-matter bank layer 618a is formed on the second interlayer dielectric film 611b as shown in FIG. 16. This inorganic-matter bank layer 618a is formed, after having formed an inorganic-matter film on the forming position, by patterning the inorganic-matter film by means of photolithography, and the like. At this time, part of the inorganic-matter bank layer 618a is formed so as to overlap with the peripheral portion of the pixel electrode 613.

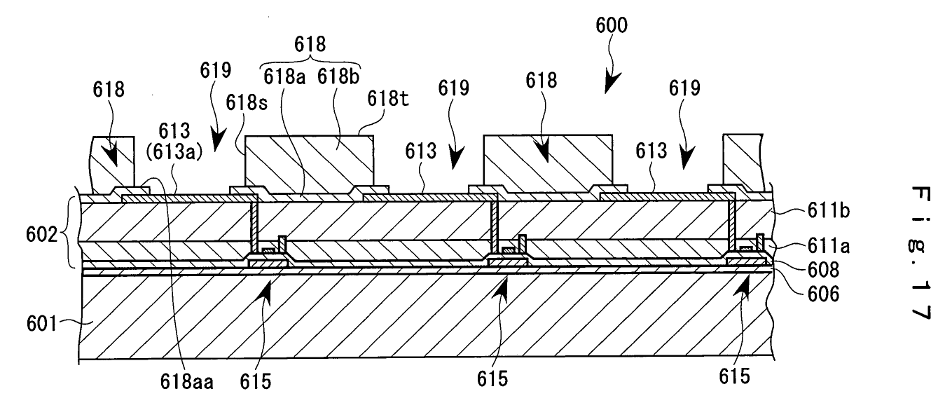

Once the inorganic-matter bank layer 618a has been formed, an organic-matter bank layer 618b is formed on the top of the inorganic-matter bank layer 618a as shown in FIG. 17. This organic-matter bank layer 618b is formed, as in the case of the inorganic-matter bank layer 618a, by patterning by means of photolithography, and the like.

The bank part 618 is formed as described above. As a result, there is formed an opening part 619 which opens in the upward direction relative to the pixel electrode 613. This opening part 619 defines a pixel region.

At the surface treatment step (S112), the liquid-affinity processing (treatment to gain affinity to liquid) and the liquid-repellency processing (treatment to gain repellency to liquid) are performed. The region in which the liquid-affinity processing is to be performed are the first laminated part 618aa of the inorganic-matter bank layer 618a and the electrode surface 613a of the pixel electrode 613. These regions are subjected to surface treatment to obtain liquid affinity by means, e.g., of plasma processing using oxygen as the processing gas. This plasma processing also serves the purpose of cleaning the ITO which is the pixel electrode 613.

The liquid-repellency processing, on the other hand, is performed on the wall surface 618s of the organic-matter bank layer 618b and on the upper surface 618t of the organic-matter bank layer 618b. By means of plasma processing with, e.g., methane tetrafluoride as the processing gas, the surface is subjected to fluoridizing processing (processed to obtain liquid-repellent characteristic).

By performing this surface processing step, it becomes possible for the function liquid droplet to reach (or hit) the pixel region in a surer manner when the function layer 617 is formed by using the function liquid droplet ejection head 17. It also becomes possible to prevent the function liquid droplet that has hit the pixel region from flowing out of the opening part 619.

By going through the above-described steps, the display device substrate 600A can be obtained. This display device substrate 600A is mounted on the setting table 22 of the liquid droplet ejection apparatus 1 as shown in FIG. 2, and the following hole injection/transport layer forming step (S113) and the light-emitting layer forming step (S114) are performed.

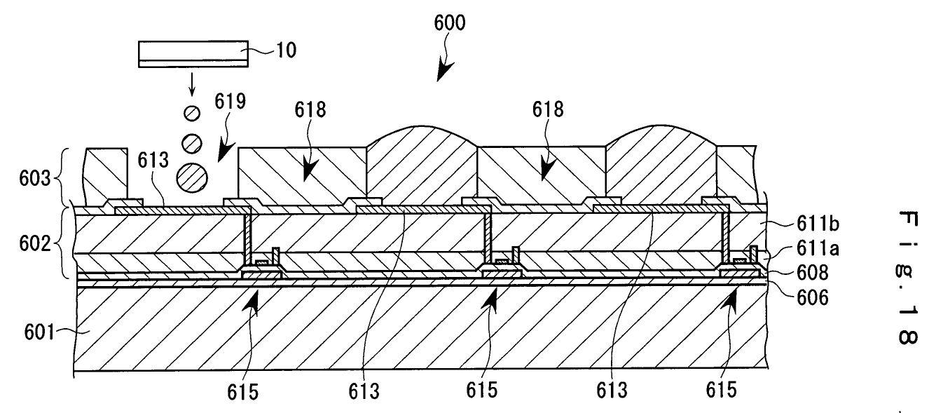

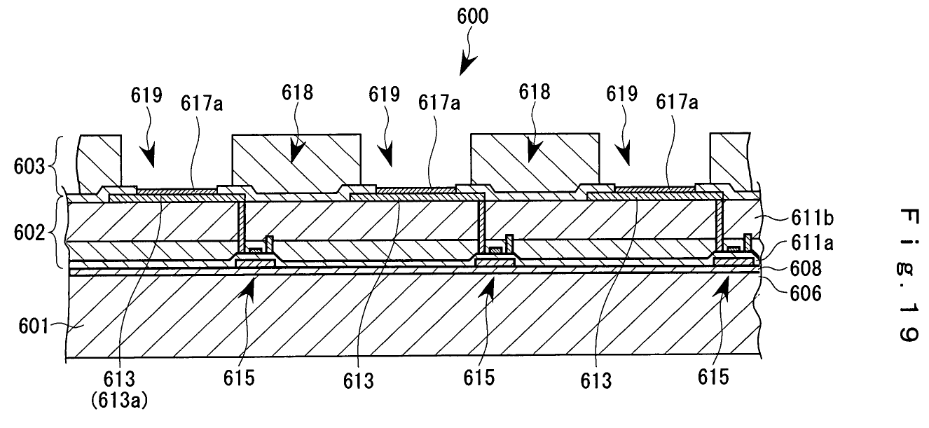

As shown in FIG. 18, at the hole injection/transport layer forming step (S113), the first composition of matter containing therein the hole injection/transport layer forming material is ejected from the function liquid droplet ejection head 17 into each of the opening parts 619 as a pixel region. Thereafter, as shown in FIG. 19, drying process and heat-treatment process are performed in order to evaporate the polar solvent contained in the first composition of matter, whereby the hole injection/transport layer 617a is formed on the pixel electrode (electrode surface 613a) 613.

A description will now be made about the light-emitting layer forming step (S114). At this light-emitting layer forming step, as described above, in order to prevent the hole injection/transport layer 617a from getting dissolved again, there is used a non-polar solvent which is insoluble to the hole injection/transport layer 617a as a solvent for the second composition of matter to be used in forming the light-emitting layer.

On the other hand, since the hole injection/transport layer 617a is low in affinity to the non-polar solvent, it will be impossible to closely adhere the hole injection/transport layer 617a to the light-emitting layer 617b or to uniformly coat the light-emitting layer 617b even if the second composition of matter containing therein the non-polar solvent is ejected onto the hole injection/transport layer 617a.

As a solution, in order to enhance the affinity of the surface of the hole injection/transport layer 617a to the non-polar solvent and to the light-emitting layer forming material, it is preferable to perform the surface treatment (treatment to improve the quality of the surface) before forming the light-emitting layer. This surface treatment is performed by coating the hole injection/transport layer 617a with a solvent which is the same as, or similar to, the non-polar solvent of the second composition of matter to be used in forming the light-emitting layer, and then drying it.

By performing this kind of treatment, the surface of the hole injection/transport layer 617a easily conforms to the non-polar solvent. It becomes thus possible to uniformly coat, at the subsequent step, the hole injection/transport layer 617a with the second composition of matter containing therein the light emitting layer forming material.

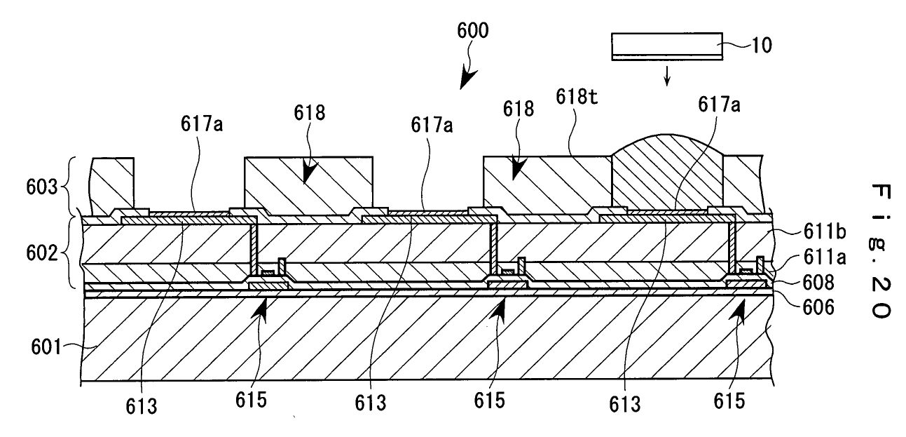

Thereafter, as shown in FIG. 20, the second composition of matter containing therein the light emitting layer forming material corresponding to one of the colors (blue in the example in FIG. 20) is implanted into the pixel region (opening part 619) as a function liquid droplet by a predetermined amount. The second composition of matter implanted into the pixel region gets spread over the hole injection/transport layer 617a to thereby fill the opening part 619. Even if the second composition of matter goes out of the pixel region to thereby hit the upper surface 618t of the bank part 618, this upper surface 618t has been subject to the liquid-repellent treatment as described above. Therefore, the second composition of matter is likely to be easily rolled into the opening part 619.

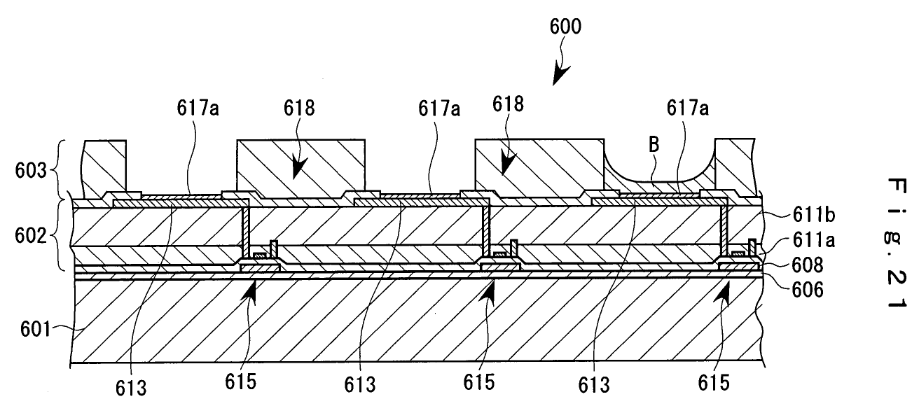

Thereafter, by performing the drying step, the second composition of matter after ejection is subjected to drying processing to thereby evaporate the non-polar solvent contained in the second composition of matter. As shown in FIG. 21, the light-emitting layer 617b is formed on the top of the hole injection/transport layer 617a. In the example shown in the figure, a light-emitting layer 617b corresponding to the color of blue (B) is formed.

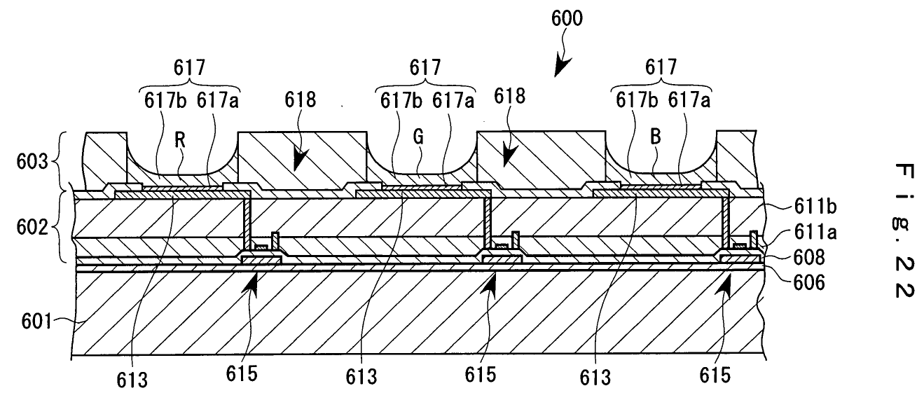

Similarly, by using the function liquid droplet ejection head 17, steps similar to those in the case of the light-emitting layer 617b corresponding to the color of blue (B) mentioned above are sequentially performed as shown in FIG. 22 to thereby form the light-emitting layers 617b corresponding to the other colors (of red (R) and green (G)). The order of steps of forming the light-emitting layer 617b are not limited to those exemplified, but may be formed in an arbitrary order. For example, the order of forming may be determined depending on the light-emitting layer forming materials. The arrangement pattern of the three colors of R, G, B may be of a stripe arrangement, a mosaic arrangement, a delta arrangement, and the like.

In the manner as described hereinabove, the function layer 617, i.e., the hole injection/transport layer 617a and the light-emitting layer 617b, is formed on the pixel electrode 613. Then, the process transfers to the opposite electrode forming step (S115).

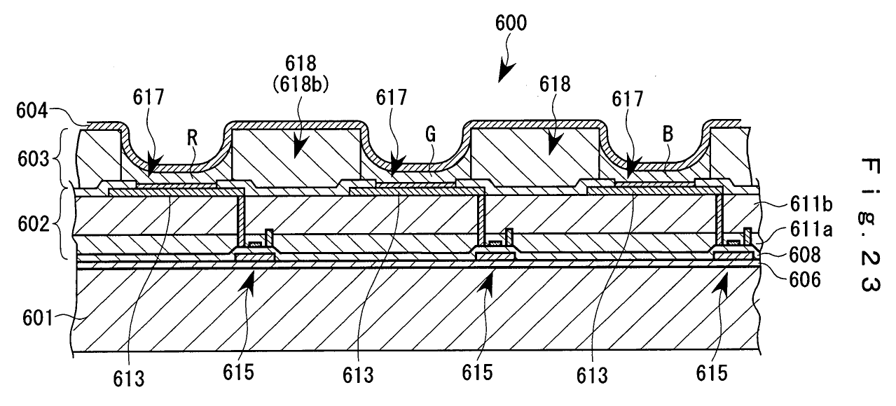

At the opposite electrode forming step (S115), as shown in FIG. 23, the cathode 604 (opposite electrode) is formed over the entire surfaces of the light-emitting layer 617b and the organic matter bank layer 618b by means, e.g., of vapor deposition method, sputtering method, chemical vapor deposition (CVD) method, and the like. This cathode 604 is constituted in this embodiment by laminating, e.g., a calcium layer and an aluminum layer.

On an upper part of the cathode 604, there are provided an Al film and an Ag film as electrodes and, on the top thereof, a protection film for preventing oxidation such as an SiO₂ film, and an SiN film, depending in necessity.

After having formed the cathode 604 as described above, a sealing process for sealing the upper portion of the cathode 604 with a sealing material, a wiring processing, and the like, are performed to thereby obtain the display device 600.

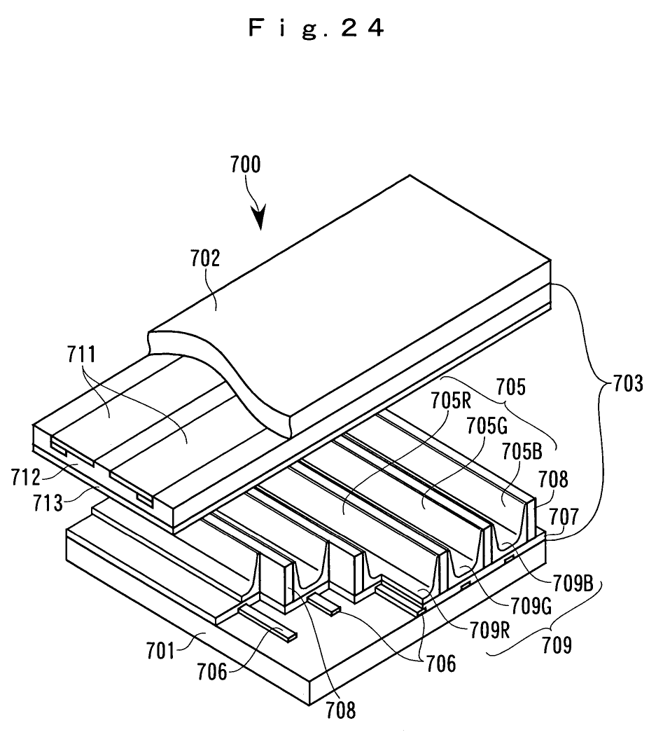

FIG. 24 is an exploded perspective view showing an important part of the plasma type of display device (PDP device, hereinafter, simply referred to as a display device 700). In FIG. 24, the display device 700 is shown in a partly cut away state.

This display device 700 is substantially made up of a first substrate 701 and a second substrate 702 which are disposed to lie opposite to each other, as well as a discharge display part 703 which is formed therebetween. The discharge display part 703 is constituted by a plurality of discharging chambers 705. Among these plurality of discharging chambers 705, the three chambers 705 of a red-color discharging chamber 705R, a green-color discharging chamber 705G, and a blue-color discharging chamber 705B are disposed as a set to make one pixel.

On the upper surface of the first substrate 701, there are formed address electrodes 706 in a stripe form at predetermined intervals from one another. A dielectric layer 707 is formed to cover these address electrodes 706 and the upper surface of the first substrate 701. On the dielectric layer 707, there are vertically disposed partition walls 708 which are positioned between respective address electrodes 707 in a manner to lie along the respective address electrodes 706. Some of these partition walls 708 extend on both widthwise sides of the address electrodes 706 and others (not shown) extend at right angles to the address electrodes 706.

The regions which are partitioned by these partition walls 708 form the discharge chambers 705.

Inside the discharge chambers 705, there are disposed fluorescent bodies 709. The fluorescent bodies 709 emit luminescent light of any one of colors of red (R), green (G) and blue (B). At the bottom of the red-color discharging chamber 705R, there are disposed red-color fluorescent bodies 709R, at the bottom of the green-color discharging chamber 705G, there are disposed green-color fluorescent bodies 709G, and at the bottom of the blue-color discharging chamber 705B, there are disposed blue-color fluorescent bodies 709B, respectively.

On the lower side of the second substrate 702 as seen in the figure, there are formed a plurality of display electrodes 711 in a direction crossing the address electrodes 706 at right angles at predetermined intervals from one another. In a manner to cover them, there are formed a dielectric layer 712 and a protection film 713 which is made of MgO, and the like.

The first substrate 701 and the second substrate 702 are oppositely adhered to each other in a state in which the address electrodes 706 and the display electrodes 711 cross each other at right angles. The address electrodes 706 and the display electrodes 711 are connected to an AC power source (not shown).

By charging electricity to each of the electrodes 706 and 711, the fluorescent bodies 709 are caused to emit light at the discharge display part 703 through excitation, whereby color display becomes possible.

In this embodiment, the address electrodes 706, the display electrodes 711, and the fluorescent bodies 709 can be formed by using the liquid droplet ejection apparatus 1 as shown in FIG. 2. A description will now be made about an example of steps for manufacturing the address electrodes 706 on the first substrate 701.

In this case, the following steps are performed in a state in which the first substrate 701 is placed on the setting table 22 of the liquid droplet ejection apparatus 1.

First, by means of the function liquid droplet ejection head 17, the liquid material (function liquid) containing therein a material for forming the conductive film wiring is caused to hit the address electrode forming region as the function liquid droplets. This liquid material is prepared as the electrically conductive film wiring (wiring formed by electrically conductive film) by dispersing electrically conductive fine particles of metals, and the like, into a dispersion medium. As the electrically conductive fine particles, there are used metallic fine particles containing therein gold, silver, copper, palladium, nickel, and the like, or an electrically conductive polymer, and the like.

Once all of the address electrode forming regions in which the liquid material is scheduled to be filled have been filled with the liquid material, the liquid material after ejection is dried to evaporate the dispersion medium contained in the liquid material, whereby the address electrodes 706 are formed.

An example of the address electrodes 706 has been given hereinabove, but the display electrodes 711 and the fluorescent bodies 709 can also be formed by the above-described steps.

In forming the display electrodes 711, a liquid material (function liquid) containing therein the material for forming the conductive film wiring is caused to hit the display electrode forming region as the function liquid droplets, in a similar manner as in the case of the address electrodes 706.

In forming the fluorescent bodies 709, on the other hand, a liquid material containing therein a fluorescent material (function liquid) corresponding to each of the colors (R, G, B) is ejected from the three function liquid droplet ejection heads 17 as liquid droplets to thereby cause them to hit the discharge chambers 705 of corresponding colors.

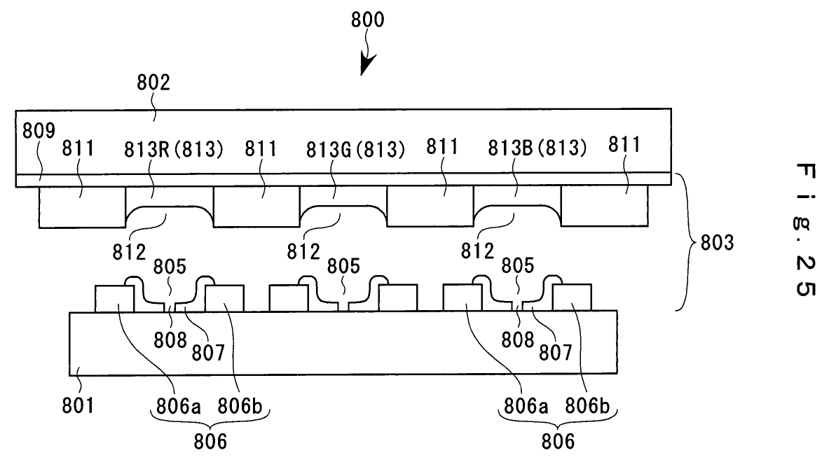

FIG. 25 is a sectional view showing an important part of the electron emission device (also referred to as an FED device or SED device; hereinafter simply referred to as a display device 800). FIG. 25 shows the display device 800 partly in section.

The display device 800 is made up of a first substrate 801 and a second substrate 802 which are disposed opposite to each other, as well as a field emission display part 803 which is formed therebetween. The field emission display part 803 is constituted by a plurality of electron emission parts 805 which are arranged in matrix.

On the upper surface of the first substrate 801, there are formed first element electrodes 806a and second element electrodes 806b which constitute cathode electrodes 806, in a manner to cross each other at right angles. In each of the portions partitioned by the first element electrodes 806a and the second element electrodes 806b, there is formed a conductive film 807 with a gap 808 formed therein. In other words, a plurality of electron emission parts 805 are constituted by the first element electrodes 806a, the second element electrodes 806b, and the conductive film 807. The conductive film 807 is made, e.g., of palladium oxide (PdO), and the like, and the gap 808 is formed by the work called forming, and the like, after having formed the conductive film 807.

On the lower surface of the second substrate 802, there is formed an anode electrode 809 which lies opposite to the cathode electrode 806. On the lower surface of the anode electrode 809, there is formed a lattice-shaped bank part 811. In each of the downward-orienting openings 812 enclosed by the bank part 811, there is disposed a fluorescent member 813 in a manner to correspond to the electron emission part 805. The fluorescent body 813 emits light of colors of either red (R), green (G), and blue (B). In each of the opening parts 812, there is disposed a red-color fluorescent body 813R, a green-color fluorescent body 813G, and a blue-color fluorescent body 813B in a predetermined pattern.

The first substrate 801 and the second substrate 802 constituted as described above are adhered to each other with a very small gap therebetween. In this display device 800, the electrons to be emitted from the first element electrode 806a and the second element electrode 806b as the cathode are excited and caused to emit light through the conductive film 807 (gap 808) by causing them to hit the fluorescent body 813 formed on the anode electrode 809 which is the anode. Color display is thus made possible.

In this case, too, as in the other embodiments, the first element electrode 806a, the second element electrode 806b, the conductive film 807, and the anode electrode 809 can be formed by using the liquid droplet ejection apparatus 1, and also fluorescent bodies 813R, 813G, 813B of each color can be formed by using the liquid droplet ejection apparatus 1.

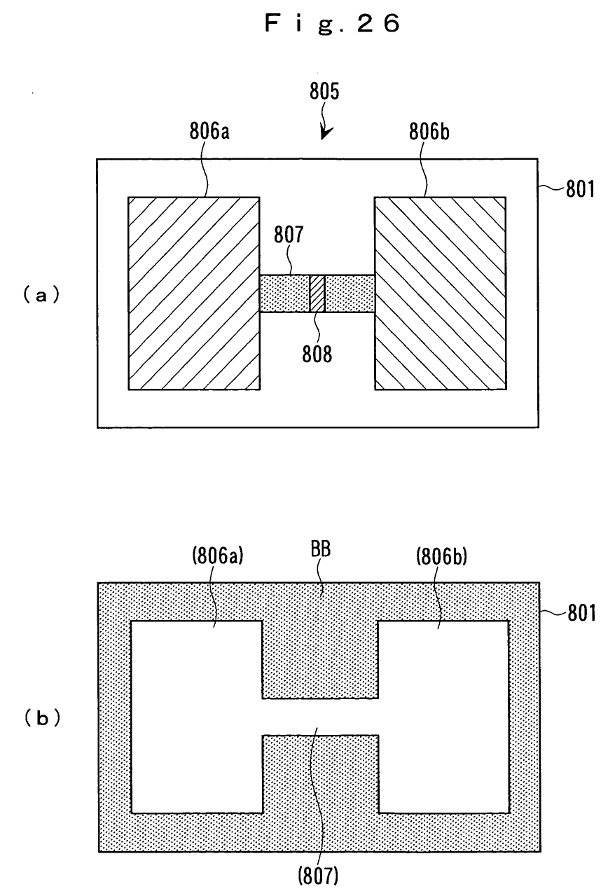

The first element electrode 806b, the second element electrode 806b, and the conductive film 807 are of a flat shape as shown in FIG. 26A. In forming them, a bank part BB is formed (in photolithography method), as shown in FIG. 26B, while leaving in advance the portions in which the first element electrode 806a, the second element electrode 806b and the conductive film 807 are to be formed. Then, the first element electrode 806a and the second element electrode 806b are formed (with ink jet method using the liquid droplet ejection apparatus 1) into the groove portions constituted by the bank parts BB. After drying the solvent therein to thereby form the film, the conductive film 807 is formed (with ink jet method using the liquid droplet ejection apparatus 1). Thereafter, the bank parts BB are removed (in ashing processing), and the process proceeds to the above-described forming steps. In the same manner as in the case of the above-described organic EL device, it is preferable to perform liquid-affinity processing to the first substrate 801 and the second substrate 802 as well as the liquid-repellency processing to the bank parts 811, and BB.

As other electro-optic devices, there are included devices of forming metallic wiring, forming lens, forming resist, forming optical dispersion body, and the like. By using the above-described liquid droplet ejection apparatus 1 in manufacturing the various electro-optic devices, such devices can be manufactured at a higher efficiency.

What is claimed is:

1. A method of correcting ejection pattern data to eliminate drawing unevenness in drawing processing in which a function liquid droplet ejection head is moved relative to a workpiece to selectively eject function liquid droplets from a plurality of nozzles of the function liquid droplet ejection head according to ejection pattern data, the method comprising the steps of:
calculating an amount of function liquid given in the drawing processing to each of a plurality of imaginary divided portions obtained by partitioning into matrix a drawing region on the workpiece;
generating matrix data which represents in multi-valued gradation an amount of function liquid given to the plurality of imaginary divided portions;
processing gradation by converting the matrix data into n-valued data to thereby generate n-valued matrix data, where n is an integer equal to or larger than 2; and
correcting ejection pattern data so as to perform at least one of decreasing and increasing the amount of function liquid given to the imaginary divided portions, the amount being decreased where each of the n-valued data of the n-valued matrix data represents the side of “large,” and the amount being increased where each of the n-valued data of the n-valued matrix data represents the side of “small,” respectively, in the amount of function liquid given to the imaginary divided portions.

2. The method according to claim 1, wherein, at the step of processing gradation, the n-valued matrix data is generated by conversion into n-valued data using one of a threshold value method, a systematic dither method, and an error diffusion method.

3. The method according to claim 1, further comprising the step of:
measuring, prior to the step of calculating an amount of function liquid, an ejection amount of the function liquid per unit shot ejected from a nozzle group made up of one or more of the nozzles corresponding to the imaginary divided portions,
wherein, at the step of calculating an amount of function liquid, the function liquid giving amount is calculated based on a result of measuring the function liquid ejection amount and the ejection pattern data.

4. The method according to claim 1, further comprising the step of:
measuring, prior to the step of calculating an amount of function liquid, an optical density, at each of the imaginary divided portions, of the film forming part formed on the workpiece by the function liquid in the drawing processing,
wherein, at the calculating step, the function liquid giving amount is calculated based on a result of measuring the optical density.

5. The method according to claim 1, further comprising the step of:
measuring, prior to the step of calculating an amount of function liquid, a film thickness, at each of the imaginary divided portions, of the film forming part formed on the workpiece by the function liquid in the drawing processing,
wherein, at the step of calculating an amount of function liquid, the function liquid giving amount is calculated based on a result of measuring the film thickness.

6. The method according to claim 1, wherein the step of correcting data corrects the ejection pattern data by at least one of increasing and decreasing the number of shots from each of the nozzles and the quantity of the function liquid ejection amount per one shot so as to increase or decrease the function liquid giving amount.

7. An apparatus for correcting ejection pattern data to eliminate drawing unevenness in drawing processing in which a function liquid droplet ejection head is moved relative to a workpiece to selectively eject function liquid droplets from a plurality of nozzles of the function liquid droplet ejection head according to ejection pattern data, the apparatus comprising:
a storing device for storing the ejection pattern data;
a calculating device for calculating an amount of function liquid given in the drawing processing to each of a plurality of imaginary divided portions obtained by partitioning in matrix a drawing region on the workpiece;
a data generating device for generating matrix data which represents in multi-valued gradation an amount of function liquid given to the plurality of imaginary divided portions;
a gradation processing device to convert the matrix data into n-valued data to thereby generate n-valued matrix data, where n is an integer equal to or larger than 2; and
a data correction device for correcting the ejection pattern data so as to perform at least one of decreasing and increasing the amount of function liquid given to the imaginary divided portions, the amount being decreased where each of the n-valued data of the n-valued matrix data represents the side of “large,” and the amount being increased where each of the n-valued data of the n-valued matrix data represents the side of “small,” respectively, in the amount of function liquid given to the imaginary divided portions.

8. A liquid droplet ejection apparatus, comprising:
a liquid droplet ejection head;
a moving device for moving the function liquid droplet ejection head relative to a workpiece; and
a head control device for controlling each of the nozzles of the function liquid droplet ejection head based on the ejection pattern data as corrected by the method of correcting ejection pattern data according to claim 1.

9. A method of manufacturing an electro-optic device comprising forming on a workpiece a film forming part by a function liquid droplet by using the liquid droplet ejection apparatus according to claim 8.

10. An electro-optic device comprising a film forming part formed on the workpiece by the function liquid by using the liquid droplet ejection apparatus according to claim 8.

11. An electronic device having mounted thereon the electro-optic device manufactured by the method of manufacturing an electro-optic device according to claim 9.

12. An electronic device having mounted thereon the electro-optic device according to claim 10.
